(19) United States
(12) Patent Application Publication
(10) Pub. No.: US 2022/0000144 A1
(43) Pub. Date: Jan. 6, 2022

(54) PROTEIN CONCENTRATION WITH HYPERTHERMOPHILIC ORGANISMS

(71) Applicant: Hyperthermics AS, Ulsteinvik (NO)

(72) Inventors: Erik Norgaard, Arendal (NO); Stefan Miller, Ulsteinvik (NO); Harald Nordal, Ulsteinvik (NO)

(21) Appl. No.: 17/283,827

(22) PCT Filed: Oct. 11, 2019
(86) PCT No.: PCT/IB2019/001096

§ 371 Date: Apr. 8, 2021

Related U.S. Application Data
(60) Provisional application No. 62/887,939, filed on Aug. 16, 2019.
(60) Provisional application No. 62/744,287, filed on Oct. 11, 2018.

(51) Int. Cl. A23K 10/12; A23J 1/00; A23K 20/147; A23J 3/20

(52) U.S. Cl. CPC A23K 10/12; A23J 1/008; A23J 3/20; A23J 1/002; A23K 20/147

(57) ABSTRACT

The present invention is directed to the utilization of hyperthermophilic organisms to produce single cell protein or protein enriched biomasses for use as food and/or feed sources. In particular, provided is the use of organic material (e.g., animal waste or sludge and/or produce) for use as a biomass in such processes.

### RELATED APPLICATIONS

This application claims priority to U.S. Provisional Application No. 62/744,287, filed Oct. 11, 2018 and to U.S. Provisional Application No. 62/887,939, filed Aug. 16, 2019, the entire contents of each of which are incorporated herein by reference.

### FIELD OF THE INVENTION

The present invention is directed to the utilization of hyperthermophilic organisms to produce single cell protein or protein enriched biomasses for use as food and/or feed sources. In particular, provided is the use of organic material (e.g., animal waste or sludge and/or produce) for use as a biomass in such processes.

### BACKGROUND OF THE INVENTION

A variety of biomass materials have been used as feed materials for fermentation processes for energy production and remediation of waste streams. The use of hyperthermophilic organisms in fermentation has been described, for example, in PCT IB2007/003772, PCT IB2009/007268, and PCT IB2013/002891, each of which is incorporated herein by reference in its entirety. Many biomass materials are of low quality as they contain pathogens and/or have low nutrient content, especially in terms of protein.

It would be advantageous to provide process for converting a low quality biomass into a material that can be used in other industries, for example, the animal feed industry.

### SUMMARY OF THE INVENTION

The present invention is directed to the utilization of hyperthermophilic organisms to produce single cell protein or protein enriched biomasses for use as food and/or feed sources. In particular, provided is the use of organic material (e.g., animal waste or sludge and/or produce) for use as a biomass in such processes.

In some preferred embodiments, the present invention provides protein compositions comprising a hyperthermophilic organism single cell protein material, the protein composition (e.g., concentrate protein powder) having a total protein content of from about 5% to 99% (e.g., 10% to 99%, 20% to 99%, 30% to 99%, etc.) on a dry w/w basis (weight of protein/total mass of composition). In some embodiments, the hyperthermophilic organism is selected from the group consisting of a member of Order Thermococcales, the Family Thermococcaceae, the Genus Pyrococcus, the Order Thermococcales, the Family Thermococcaceae, the Genus Thermococcus, the Order Thermococcales, the Family Thermococcaceae, the Genus Palaeococcus, the Order Thermales, the Family Thermaceae, the Genus Thermus, and the Order Thermotogales, the Family Thermotogaceae, the Genus Thermotoga. In some particularly preferred embodiments, the hyperthermophilic organism is from a genus selected from the group consisting of Pyrococcus, Thermococcus, Palaeococcus, Thermus, and Thermotoga. In some embodiments, composition comprises DNA from the hyperthermophilic organism. In some embodiments, the protein composition is substantially free of living or active pathogenic organisms.

In some embodiments, the composition additionally comprises protein from a biomass other than the hyperthermophilic organisms. In some embodiments, the biomass is selected from the group consisting of fish waste, fish sludge, sewage, agricultural waste products, brewery grain by-products (e.g., brewery spent grain), food industry waste (e.g., spent coffee grounds, and fruit and vegetables past shelf-life), organic industry waste, forestry waste, crops, grass, seaweed, plankton, algae (e.g., microalgae biomass), fish, fish waste, corn potato waste, cocoa waste, mushroom compost (spent or fresh), sugar cane waste, sugar beet waste, straw, paper waste, chicken manure, cow manure, hog manure, horse manure, switchgrass and combinations thereof. In some embodiments, fish sludge comprises fish feces and waste or uneaten fish feed. In some embodiments, protein composition further comprises DNA and/or RNA from the biomass.

In some embodiments, the protein composition is a dry powder having a moisture content of less than 8%.

In some embodiments, the present invention provides an animal feed comprising a protein composition as described above. In some embodiments, the animal feed comprises at least one of a protein source, carbohydrate source, fat source, mineral source, or vitamin source from a source or organism other than the hyperthermophilic organism.

In some embodiments, the animal feed is pelleted. In some embodiments, the present invention provides a food or feed supplement comprising a protein composition as described above and at least one of a protein source, carbohydrate source, fat source, mineral source, or vitamin source from a source or organism other than the hyperthermophilic organism. In some embodiments, the present invention provides a sealed container containing the protein composition of claim 1. In some embodiments, the sealed container contains greater than about 500 g of the protein composition. In some embodiments, the sealed container contains greater than about 10 kg of the protein composition. In some embodiments, the sealed container contains greater than about 100 kg of the concentrated protein powder.

In some embodiments, the present invention provides methods of feeding an animal comprising orally administering a protein composition, feed, or feed or supplement as described above to an animal. In some embodiments, the animal is a domestic animal selected from the group consisting of a cow, pig, sheep, horse, goat, chicken, duck or goose. In some embodiments, the animal is a companion animal. In some embodiments, the animal is a fresh or saltwater aquatic organism. In some embodiments, the animal is a fish or shrimp. In some embodiments, the animal is an invertebrate. In some embodiments, the animal is a human.

In some embodiments, the present invention provides a protein composition, feed, or feed or supplement as described above for use in supplementing the diet or feeding of an animal. In some embodiments, the animal is a domestic animal selected from the group consisting of a cow, pig, sheep, horse, goat, chicken, duck or goose. In some embodiments, the animal is a companion animal. In some embodiments, the animal is a fresh or saltwater aquatic organism. In some embodiments, the animal is a fish or shrimp. In some embodiments, the animal is an invertebrate. In some embodiments, the animal is a human.

In some embodiments, the present invention provides processes for producing a hyperthermophilic organism protein composition comprising: a) fermenting a biomass material with a hyperthermophilic organism at a temperature of greater than 70° C. to provide a hyperthermophilic fermentation culture; and b) recovering a protein composition from the hyperthermophilic fermentation culture. In some embodiments, the biomass material is selected from the group consisting of fish waste, fish sludge, sewage, agricultural waste products, brewery grain by-products (e.g., brewery spent grain), food industry waste (e.g., spent coffee grounds, and fruit and vegetables past shelf-life), organic industry waste, forestry waste, crops, grass, seaweed, plankton, algae (e.g., microalgae biomass), fish, fish waste, corn potato waste, cocoa waste, mushroom compost (spent or fresh), sugar cane waste, sugar beet waste, straw, paper waste, chicken manure, cow manure, hog manure, horse manure, switchgrass and combinations thereof. In some embodiments, fish sludge comprises fish feces and waste or uneaten fish feed. In some embodiments, the hyperthermophilic organism is selected from the group consisting of the Order Thermococcales, the Family Thermococcaceae, the Genus Pyrococcus, the Order Thermococcales, the Family Thermococcaceae, the Genus Thermococcus, the Order Thermococcales, the Family Thermococcaceae, the Genus Palaeococcus, the Order Thermales, the Family Thermaceae, the Genus Thermus, and the Order Thermotogales, the Family Thermotogaceae, the Genus Thermotoga. In some particularly preferred embodiments, the hyperthermophilic organism is from a genus selected from the group consisting of Pyrococcus, Thermococcus, Palaeococcus, Thermus, and Thermotoga.

In some embodiments, the fermenting step produces hydrogen and the hydrogen is combusted to provide heat and energy. In some embodiments, the recovered protein composition further comprises DNA, RNA, sugars, or lipids from the hyperthermophilic organisms. In some embodiments, the recovered protein composition further comprises protein from the biomass material on which the hyperthermophilic organisms are cultured. In some embodiments, the recovered protein composition further comprises DNA from the biomass material on which the hyperthermophilic organisms are cultured. In some embodiments, the recovering further comprising concentrating the recovered protein composition by a process selected from the group consisting of coagulation, flocculation, direct drying, spraying drying and vacuum drying and combinations thereof to provide a powder. In some embodiments, the fermenting step hygienizes the biomass so that the recovered protein composition is substantially free of living or active pathogenic organisms.

In some embodiments, the process further comprise incorporating the recovered protein composition into a feed or food supplement.

In some embodiments, the processes further comprise introducing acetate from the hyperthermophilic fermentation culture into a purple nonsulfur bacteria fermentation culture under conditions where the purple nonsulfur bacteria fermentation culture produces hydrogen.

In some embodiments, the present invention provides a feed or food supplement made the foregoing processes.

In some embodiments, the present invention provides processes for making an animal feed comprising: combining a protein composition as described above with at least one of a protein source, carbohydrate source, fat source, mineral source, or vitamin source from a source or organism other than the hyperthermophilic organism in the protein composition.

In some embodiments, the present invention provides processes for producing a proteinaceous vector comprising feeding the protein composition as described above to an invertebrate protein vector. In some embodiments, the invertebrate protein vector is selected from the group consisting of fly larvae and worms. In some embodiments, the processes further comprise feeding the invertebrate protein vector to a domestic animal.

In some embodiments, the present invention provides processes comprising providing fish sludge and a population of hyperthermophilic organisms; and degrading the fish sludge in the presence of the population of hyperthermophilic organisms at a temperature of above 70 degrees C. and preferably above about 80 degrees C. under conditions such that degradation products are produced. In some embodiments, the degradation products are selected from the group consisting of hydrogen and acetate. In some embodiments, the processes further comprise the step of converting the acetate to methane in a biogas reactor. In some embodiments, the processes further comprise the steps of converting the degradation products to energy.

In some embodiments, the hyperthermophilic organism is selected from the group consisting of the Order Thermococcales, the Family Thermococcaceae, the Genus Pyrococcus, the Order Thermococcales, the Family Thermococcaceae, the Genus Thermococcus, the Order Thermococcales, the Family Thermococcaceae, the Genus Palaeococcus, the Order Thermales, the Family Thermaceae, the Genus Thermus, and the Order Thermotogales, the Family Thermotogaceae, the Genus Thermotoga. In some particularly preferred embodiments, the hyperthermophilic organism is from a genus selected from the group consisting of Pyrococcus, Thermococcus, Palaeococcus, Thermus, and Thermotoga. In some embodiments, the degradation step hygienizes the fish sludge so that it is substantially free of living or active pathogenic organisms. In some embodiments, the fish sludge comprises fish feces and waste or uneaten fish feed.

In some embodiments, the processes further comprise the step of recovering a protein composition after the degradation step. In some embodiments, the recovered protein composition further comprises DNA from the hyperthermophilic organisms. In some embodiments, the recovered protein composition further comprises protein from the biomass material on which the hyperthermophilic organisms are cultured. In some embodiments, the recovered protein composition further comprises DNA from the biomass material on which the hyperthermophilic organisms are cultured.

In some embodiments, the recovering further comprising concentrating the recovered protein composition by a process selected from the group consisting of coagulation, flocculation, direct drying, spraying drying and vacuum drying and combinations thereof to provide a powder.

In some embodiments, the processes further comprise incorporating the recovered protein composition into a feed or food supplement.

In other preferred embodiments, the present invention provides a concentrated protein powder comprising a hyperthermophilic organism single cell protein material, the concentrate protein powder having a total protein content of from about 20% to 99% on a w/w basis (weight of protein/total mass of powder). In some embodiments, the hyperthermophilic organism is from a genus selected from the group consisting of Pyrococcus, Thermococcus, Palaeococcus, Thermus, and Thermotoga. In some embodiments, the powder is substantially free of living or active pathogenic organisms (bacteria or viruses).

In some embodiments, the present invention provides an animal feed comprising the concentrated protein powder described herein. In some embodiments, the animal feed comprises at least one of a protein source, carbohydrate source, fat source, mineral source, or vitamin source from a source or organism other than the hyperthermophilic organism in the hyperthermophilic organism single cell protein material. In some embodiments, the animal feed is pelleted.

In some embodiments, the present invention provides a food or feed supplement comprising the concentrated protein powder described herein and at least one of a protein source, carbohydrate source, fat source, mineral source, or vitamin source from a source or organism other than the hyperthermophilic organism in the hyperthermophilic organism single cell protein material.

In some embodiments, the present invention provides a sealed container containing the concentrated protein powder described herein. In some embodiments, the sealed container contains greater than about 500 g of the concentrated protein powder. In some embodiments, the sealed container contains greater than about 1 kg of the concentrated protein powder. In some embodiments, the sealed container contains greater than about 10 kg of the concentrated protein powder.

In some embodiments, the present invention provides a method of feeding an animal comprising orally administering a concentrated protein powder, feed, or feed or supplement as described herein to an animal. In some embodiments, the present invention provides for the use of a concentrated protein powder, feed, or feed or supplement as described herein for supplementing the diet or feeding of an animal. In some embodiments, the animal is a domestic animal selected from the group consisting of a cow, pig, sheep, horse, goat, chicken, duck or goose. In some embodiments, the animal is a companion animal. In some embodiments, the animal is a fish. In some embodiments, the animal is a shrimp. In some embodiments, the animal is an invertebrate. In some embodiments, the animal is a human.

In some embodiments, the present invention provides a process for producing a hyperthermophilic organism single cell protein material comprising: a) fermenting a biomass material with a hyperthermophilic organism at a temperature of greater than 80° C. to provide a hyperthermophilic fermentation culture; b) recovering a single cell protein material from the hyperthermophilic fermentation culture. In some embodiments, the biomass material is selected from the group consisting of sewage, agricultural waste products, brewery grain by-products (e.g., brewery spent grain), food industry waste (e.g., spent coffee grounds), organic industry waste, forestry waste, crops, fruit, grass, seaweed, plankton, algae (e.g., microalgae biomass), fish, fish waste, corn potato waste, cocoa waste, mushroom compost (spent or fresh), sugar cane waste, sugar beet waste, straw, paper waste, chicken manure, cow manure, hog manure, horse manure, switchgrass and combinations thereof. In some embodiments, the hyperthermophilic organism is from a genus selected from the group consisting of Pyrococcus, Thermococcus, Palaeococcus, Thermus, and Thermotoga. In some embodiments, before step a, the biomass material is pretreated. In some embodiments, the pretreatment comprises a process selected from the group consisting of chemical hydrolysis, thermal hydrolysis, and enzymatic hydrolysis. In some embodiments, the fermenting step produces hydrogen and the hydrogen combusted to provide heat for the pretreatment. In some embodiments, the recovering further comprising concentrating the single cell protein material by a process selected from the group consisting of coagulation, flocculation, filtering, direct drying, spraying drying and vacuum drying and combinations thereof to provide a single cell protein concentrate powder. In some embodiments, the processes further comprise formulating a feed or food supplement containing the single cell protein concentrate powder. In some embodiments, the processes further comprise introducing acetate from the hyperthermophilic fermentation culture into a purple nonsulfur bacteria fermentation culture under conditions where the purple nonsulfur bacteria fermentation culture produces hydrogen.

In some embodiments, the present invention provides a process for making an animal feed comprising: combining the concentrated protein powder comprising a hyperthermophilic organism single cell protein material as described herein with at least one of a protein source, carbohydrate source, fat source, mineral source, or vitamin source from a source or organism other than the hyperthermophilic organism in the hyperthermophilic organism single cell protein material.

In some embodiments, the present invention provides a process for producing a proteinaceous vector comprising feeding the protein concentrate as described herein to an invertebrate protein vector. In some embodiments, the invertebrate protein vector is selected from the group consisting of fly larvae and worms. In some embodiments, the processes further comprise feeding the invertebrate protein vector to a domestic animal.

### BRIEF DESCRIPTION OF THE DRAWINGS

FIG. 1: Flow chart of protein production process utilizing fish sludge

FIG. 2: Thermotoga MH1 growth.

FIG. 3: Thermotoga Lepl10 growth.

FIG. 4: Staggered overlay of the four NMR spectra (signal intensity vs ppm)—relative intensities. (bioretur=BR)

FIG. 5: Staggered overlay of the four NMR spectra (signal intensity vs ppm)—spectral region with mainly carbohydrate signals. (bioretur=BR)

FIGS. 6A and 6B: Analysis of the amino acid content (6A) and other metabolites (6B).

FIGS. 7A and 7B: Analysis of the amino acid content (7A) and other metabolites (7B).

FIGS. 8A and 8B: Analysis of Thermotoga growth, ORP, dV/dt (8A) and total exh. gas 8B) for a biomass comprising 5.0% fruits and vegetables.

FIGS. 9A and 9B: Analysis of Thermotoga growth, ORP, dV/dt (9A) and total exh. gas 9B) for a biomass comprising 10.0% fruits and vegetables.

FIGS. 10A and 10B: Analysis of Thermotoga growth, ORP, dV/dt (10A) and total exh. gas 10B) for a biomass comprising 20.0% fruits and vegetables.

FIGS. 11A and 111B: Levels of amino acids after fermentation of a biomass comprising 5.0% fruits and vegetables by Thermotoga.

FIGS. 12A and 12B: Levels of carbohydrates and other metabolites after fermentation of a biomass comprising 5.0% fruits and vegetables by Thermotoga.

FIGS. 13A and 13B: Levels of amino acids after fermentation of a biomass comprising 10.0% fruits and vegetables by Thermotoga.

FIGS. 14A and 14B: Levels of carbohydrates and other metabolites after fermentation of a biomass comprising 10.0% fruits and vegetables by Thermotoga.

FIGS. 15A and 15B: Levels of amino acids after fermentation of a biomass comprising 20.0% fruits and vegetables by Thermotoga.

FIGS. 16A and 16B: Levels of carbohydrates and other metabolites after fermentation of a biomass comprising 20.0% fruits and vegetables by Thermotoga.

### DEFINITIONS

As used herein, the term “biomass” refers to biological material which can be used as fuel or for industrial production. Most commonly, biomass refers to plant matter grown for use as biofuel, but it also includes plant or animal matter used for production of fibers, chemicals or heat. Biomass may also include biodegradable wastes that can be used as fuel. It is usually measured by dry weight. The term biomass is useful for plants, where some internal structures may not always be considered living tissue, such as the wood (secondary xylem) of a tree. This biomass became produced from plants that convert sunlight into plant material through photosynthesis. Sources of biomass energy lead to agricultural crop residues, energy plantations, and municipal and industrial wastes. The term “biomass,” as used herein, excludes components of traditional media used to culture microorganisms, such as purified starch, peptone, yeast extract but includes waste material obtained during industrial processes developed to produce purified starch. According to the invention, biomass may be derived from a single source, or biomass can comprise a mixture derived from more than one source; for example, biomass could comprise a mixture of corn cobs and corn stover, or a mixture of grass and leaves. Biomass includes, but is not limited to, fish waste, fish sludge, bioenergy crops, agricultural residues, municipal solid waste, industrial solid waste, sludge from paper manufacture, yard waste, wood and forestry waste. Examples of biomass include, but are not limited to, corn grain, corn cobs, crop residues such as corn husks, corn stover, corn steep liquor, grasses, wheat, wheat straw, barley, barley straw, grain residue from barley degradation during brewing of beer, hay, rice straw, switchgrass, waste paper, sugar cane bagasse, sorghum, soy, components obtained from processing of grains, trees, branches, roots, leaves, wood chips, sawdust, shrubs and bushes, soybean hulls, vegetables, fruits, flowers and animal manure.

As used herein, the term “biomass by-products” refers to biomass materials that are produced from the processing of biomass.

As used herein, the term “bioreactor” refers to an enclosed or isolated system for containment of a microorganism and a biomass material. The “bioreactor” may preferably be configured for anaerobic growth of the microorganism.

As used herein, the term “hyperthermophilic organism” means an organism which grows optimally at temperatures above 80° C.

As used herein, the term “thermophilic organism” means an organism which grows optimally at temperatures between 60° C. and 80° C.

As used herein, the terms “degrade” and “degradation” refer to the process of reducing the complexity of a substrate, such as a biomass substrate, by a biochemical process, preferably facilitated by microorganisms (i.e., biological degradation). Degradation results in the formation of simpler compounds such as methane, ethanol, hydrogen, and other relatively simple organic compounds (i.e., degradation products) from complex compounds. The term “degradation” encompasses anaerobic and aerobic processes, including fermentation processes.

As used herein, the term “single cell protein” refers to protein produced or derived from the culture of a single-celled organism that is suitable for use as a feedstock for animals and/or humans.

As used herein, the term “protein composition” refers, for example, to a product of biomass fermentation described herein (e.g., a protein powder or other formulation). The “protein composition” can include one or more of full length proteins, protein fragments, peptides, and free amino acids.

### DETAILED DESCRIPTION OF THE INVENTION

The present invention is directed to the utilization of hyperthermophilic organisms to produce single cell protein or protein enriched biomasses for use as food sources. As described in more detail below, a variety of biomasses can be digested or fermented by hyperthermophilic organisms as disclosed in PCT IB2007/003772, PCT IB2009/007268, and PCT IB2013/002891, each of which is incorporated herein by reference in its entirety. In some embodiments, the biomass is pretreated prior to the hyperthermophilic fermentation step by chemical hydrolysis (e.g., acidic, alkaline or combined acidic and alkaline treatment), enzymatic hydrolysis, high pressure treatment, and/or thermal hydrolysis and combinations thereof. The present invention utilizes protein compositions produced by the culture of hyperthermophilic organisms on a biomass as a feed source for humans and other animals, including, but not limited to, livestock such as cattle, sheep, pigs, goats, horses, chickens, ducks, geese and other domestic livestock, companion animals such as dogs and cats, fresh water and marine organisms such as fish and shrimp and invertebrates such as worms and fly larvae. In some embodiments, the protein composition is combined with a protein source, carbohydrate source and/or fat and combinations thereof to produce an animal ration or feed supplement for oral consumption by the animal. In some embodiments, the protein source, carbohydrate source and/or fat and combinations thereof are from an organism (e.g., a plant, animal or microorganism) other than the hyperthermophilic organism used in the hyperthermophilic fermentation process.

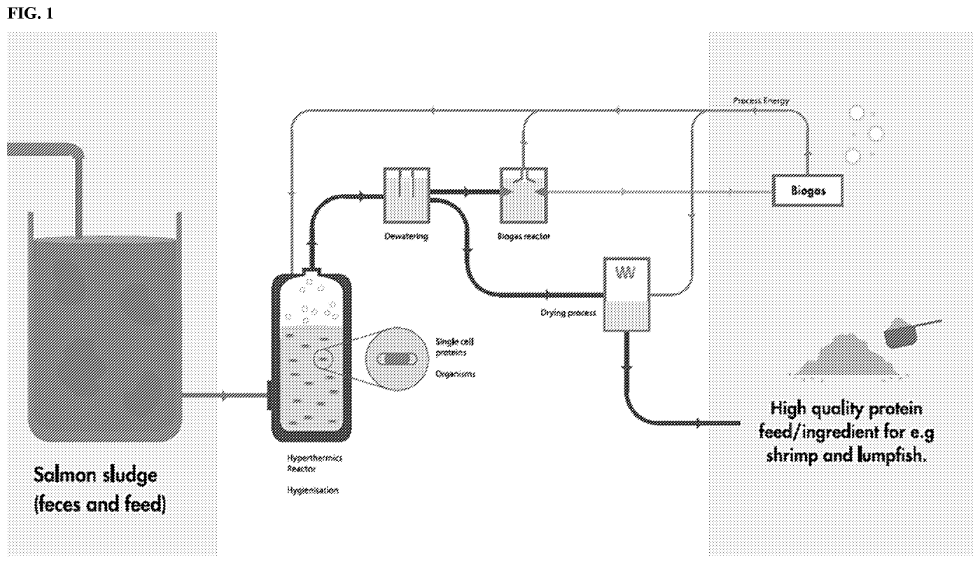

A preferred process of the present invention is depicted in FIG. 1. As shown in FIG. 1, fish sludge is fed into a hyperthermophilic (HT) bioreactor. Hydrogen and protein are recovered from the HT bioreactor. Acetate from the bioreactor is fed into a methane bioreactor for production of methane. The invention is described in more detail below.

A. Biomass and Organic Matter

The present invention contemplates the degradation of biomass with hyperthermophilic organisms. The present invention is not limited to the use of any particular biomass or organic matter. Suitable biomass and organic matter includes, but is not limited to, fish waste, fish sludge, sewage, agricultural waste products, brewery grain by-products (e.g., brewery spent grain), food industry waste (e.g., spent coffee grounds), organic industry waste, forestry waste, crops, grass, seaweed, plankton, algae (e.g., microalgae biomass), fish, fish waste, corn potato waste, cocoa waste, mushroom compost (spent or fresh), sugar cane waste, sugar beet waste, straw, paper waste, chicken manure, cow manure, hog manure, horse manure, switchgrass and combinations thereof. In some embodiments, the biomass is harvested particularly for use in hyperthermophilic degradation processes, while in other embodiments waste or by-products materials from a pre-existing industry are utilized.

In some preferred embodiments, the biomass is fish sludge. Fish sludge is waste material from closed or open fish farming operations and comprises fish feces and non-digested or uneaten fish feed that has been provided to the fish. Fish sludge may be from fresh or marine farming operations. Fish sludge typically comprise from about 20 to 40% protein, 17 to 37% fiber, 1 to 5% carbohydrates, 5 to 15% fat, and 20 to 40% ash as determined by proximate analysis. In some preferred embodiments, the fish sludge is preferably substantially free from flocculants and/or polymeric settling agents as those agents may inhibit growth of the hyperthermophilic organisms. Fish sludge from marine (salt-water) farming comprises a substantial amount of salt. It is contemplated that hyperthermophilic organisms are uniquely suited to processing of biomasses with high salt contents.

B. Biomass Pretreatment

In some preferred embodiments, the biomass is lignocellulosic (e.g., brewery spent grain, spent coffee grounds, cocoa waste, microalgae, as well as most of the other sources identified above). Lignocellulosic biomass, as a structural material, has natural resistance to enzymatic deconstruction for production of fermentable sugars. In some embodiments, the biomass is pretreated to increase accessibility to cellulose and other fermentable carbohydrates and polysaccharides in the biomass. The present invention contemplates the use of variety of biomass pretreatment steps. Suitable pretreatment processes include chemical (e.g., acid and/or alkaline hydrolysis), enzymatic and thermal hydrolysis. It will be understood that the pretreatment methods may be used alone or in combination (e.g., chemical hydrolysis followed by thermal hydrolysis and then enzymatic hydrolysis, thermal hydrolysis followed by chemical hydrolysis, acid and alkaline hydrolysis in combination, etc.).

In some embodiments, the pretreatment is carried out in a reactor where the biomass, water (preferably in a vapor form) and any necessary chemical compounds can be introduced. In some embodiments, the reactor is heated and/or the biomass is heated prior to introduction into the reactor, for example by passage through a contherm heat exchanger. The pretreatment role is to make the cellulose accessible to enzymes by destructuring the lignocellulosic matrix. During pretreatment, preferably the hemicellulose is attacked, which for the most part is dissolved in the liquid phase.

In some embodiments, an alkaline pretreatment is carried out in the reactor. For example, in some embodiments, the pretreatment comprises treatment with sodium sulfate in a variation of the Kraft process. In other embodiments, the alkaline chemical pretreatment carried out in the reactor is preferably a pretreatment by explosion of the fibers with ammonia, also called AFEX (Ammonia Fiber Explosion) pretreatment, or pretreatment by percolation using ammonia with recycling, also called ARP (Ammonia Recycle Percolation) pretreatment.

The process with sodium sulfate or the Kraft process is based on the use of soda and sodium sulfate. The chemical treatment of the wood chips is done at 150-175° C. for a period of 1 to 7 hours based on the substrate that is used. The Kraft papermaking pastes are produced from the most varied biomasses but more particularly from the resinous arborescent types (softwood such as spruce or pine) or leafy arborescent types (hardwood such as eucalyptus) or else agricultural lignocellulosic waste (wheat straw, rice, etc.). They are partially delignified by means of high-temperature baking and in the presence of soda. This delignification is controlled by the operating parameters of the reactors. The baking is done in a vertical reactor, where the chips drop by gravity and meet the various baking liquors. The sodium sulfide is prepared directly from sodium sulfate by combustion. During baking, the sodium sulfide is hydrolyzed with soda, NaHS, and H₂S. The different sulfur-containing compounds that are present react with lignin to provide thiolignins that are more easily soluble. The liquor applied to the chips is called white liquor. The liquor extracted from the reactor or digester containing the compounds eliminated from the wall is called black liquor. At the end of this alkaline pretreatment, the result is the production of a pretreated substrate, enriched with cellulose since it contains between 60 and 90% cellulose and between 5 and 20% hemicellulose.

The ARP (Ammonia Recycle Percolation) process is a pretreatment process using ammonia with recycling. This type of process is described in particular by Kim et al., 2003, Biores. Technol. 90 (2003), pp. 39-47. The high temperature of the percolation leads to a partial solubilization of both lignin and hemicelluloses; this solution is next heated for recycling ammonia and for recovering, on the one hand, the extracted lignin, for example for an energy upgrade, and, on the other hand, soluble sugars coming from hemicelluloses.

The AFEX (Ammonia Fiber Explosion) process comprises introducing the lignocellulosic substrate into a high-pressure cooker in the presence of ammonia and then causing an explosive pressure relief at the outlet of the reactor and recycling ammonia that is then in gaseous form. This type of process is described in particular by Teymouri et al., 2005, Biores. Technol. 96 (2005), pp. 2014-2018. This process primarily leads to a destructuring of the matrix of the biomass, but there is no phase separation of the lignin, hemicellulose, and cellulose compounds at the treatment outlet.

In other embodiments, an acid pretreatment is carried out in the reactor. For example, in some embodiments, the pretreatment comprises a baking-type pretreatment with dilute acid. In this embodiment, the biomass is brought into contact with a strong acid that is diluted in water, for example sulfuric acid, by using the biomass at low contents of dry materials, generally between 5 and 20% dry material. The biomass, acid, and water are brought into contact in a reactor and raised in temperature, generally between 120° C. and 200° C. During this process, the hemicellulosic compounds are primarily hydrolyzed into sugars, making it possible to destructure the lignocellulosic matrix. At the end of this acid pretreatment, the result is the production of a solid pretreated substrate, enriched with cellulose and lignin, as well as a liquid fraction that is enriched with sugars.

In some preferred embodiments, the biomass is subjected to thermal hydrolysis. In some embodiments, “vapor explosion,” or “SteamEx” or “steam explosion” processes are performed in the reactor. This is a process in which the lignocellulosic biomass is brought into contact with water in a reactor with a short dwell time, generally between 2 and 15 minutes, and at moderate temperatures, generally between 120° C. and 250° C., and at a pressure of between 5 and 50 atmospheres, preferably from 6 to about 8 atmospheres. Water can be supplemented with an acid compound, for example sulfuric acid, or a base compound. At the outlet of the reactor, the biomass is expanded, for example to atmospheric pressure, in a gas/solid separator receptacle so as to produce a pretreated biomass with a high level of dry material, generally between 20 and 70% dry material.

In some embodiments, the biomass is subjected to enzymatic hydrolysis. In these embodiments, suitable enzymes are introduced into the reactor. The enzymes may include cellulases (e.g., endoglucanases and exoglucanases) and hemicellulases. The effective hydrolysis conditions may include a maximum temperature of 75° C. or less, preferably 65° C. or less, within the reactor. Various cellulase enzymes may be utilized in the liquefaction-focused blend of enzymes, such as one or more enzymes recited in Verardi et al., “Hydrolysis of Lignocellulosic Biomass: Current Status of Processes and Technologies and Future Perspectives,” Bioethanol, Prof. Marco Aurelio Pinheiro Lima (Ed.), ISBN: 978-953-51-0008-9, InTech (2012), which is hereby incorporated by reference.

Some embodiments employ thermostable enzymes obtained from thermophilic microrganisms or hyperthermophilic organisms. The unique stability of the enzymes produced by these microrganisms at elevated temperatures, extreme pH and high pressure (up to 1000 bar) makes them valuable for processes at harsh conditions. Also, thermophilic enzymes have an increased resistance to many denaturing conditions such as the use of detergents which can be an efficient means to obviate the irreversible adsorption of cellulases on the substrates. Furthermore, the utilization of high operation temperatures, which cause a decrease in viscosity and an increase in the diffusion coefficients of substrates, have a significant influence on the cellulose solubilization. Most thermophilic cellulases do not show inhibition at high level of reaction products (e.g. cellobiose and glucose). As consequence, higher reaction rates and higher process yields are expected. The high process temperature also reduces contamination. See Table 6, “Thermostable cellulases” in Verardi et al., cited above, for exemplary thermotolerant enzymes that may be used in the pretreatment embodiments described herein.

It will be recognized that several of the pretreatment processes described above require that the biomass be heated. It is contemplated that the use of the pretreated and heated biomass as a substrate for fermentation by hyperthermophilic organisms allows efficient utilization of the energy input into the pretreatment process as the heated effluent from the pretreatment step may be introduced in a hyperthermophilic fermentation reactor in a temperature range from about 80° C. to 100° C. and most preferably at about 90° C. Likewise, biomasses that are of low value or which are likely to contain human pathogens (e.g., manure such as cow, chicken, horse, or pig manure) or mushroom compost) may preferably be sterilized and reduced to a more homogenous pulp by thermal hydrolysis and introduced into the hyperthermophilic fermentation reactor.

C. Hyperthermophilic Fermentation

The present invention contemplates the use of hyperthermophilic organism for fermenting biomass, either untreated or preferably pretreated as described above. Thermophilic bacteria are organisms which are capable of growth at elevated temperatures. Unlike the mesophiles, which grow best at temperatures in the range of 25-40° C., or psychrophiles, which grow best at temperatures in the range of 15-20° C., thermophiles grow best at temperatures greater than 50° C. Indeed, some thermophiles grow best at 65-75° C., and hyperthermophiles grow at temperatures higher than 80° C. up to 113° C. (See e.g., J. G. Black, Microbiology Principles and Applications, 2d edition, Prentice Hall, New Jersey, [1993] p. 145-146; Dworkin, M., Falkow, S., Rosenberg, E, Schleifer, K-H., Stackebrandt E. (eds) The prokaryotes, third edition, volume 3, p. 3-28296 and p. 797-814 and p. 899-924; Madigan M., Martinko, J. Brock Biology of Microorganisms, eleventh edition, p. 430-441 and 414-415).

The thermophilic bacteria encompass a wide variety of genera and species. There are thermophilic representatives included within the phototrophic bacteria (i.e., the purple bacteria, green bacteria, and cyanobacteria), bacteria (i.e., Bacillus, Clostridium, Thiobacillus, Desulfotomaculum, Thermus, Lactic acid bacteria, Actinomycetes, Spirochetes, and numerous other genera). Many hyperthermophiles are archaea (i.e., Pyrococcus, Thermococcus, Sulfolobus, and some methanogens) but there are also some bacteria (e.g., Thermotoga). There are aerobic as well as anaerobic thermophilic organisms. Thus, the environments in which thermophiles may be isolated vary greatly, although all of these organisms are isolated from areas associated with high temperatures. Natural geothermal habitats have a worldwide distribution and are primarily associated with tectonically active zones where major movements of the earth's crust occur. Thermophilic bacteria have been isolated from all of the various geothermal habitats, including boiling springs with neutral pH ranges, sulfur-rich acidic springs, and deep-sea vents. In general, the organisms are optimally adapted to the temperatures at which they are living in these geothermal habitats (T. D. Brock, “Introduction: An overview of the thermophiles,” in T. D. Brock (ed.), Thermophiles: General, Molecular and Applied Microbiology, John Wiley & Sons, New York [1986], pp. 1-16; Madigan M., Martinko, J. Brock Biology of Microorganisms, eleventh edition, p. 442-446 and p. 299-328). Basic, as well as applied research on thermophiles has provided some insight into the physiology of these organisms, as well as promise for use of these organisms in industry and biotechnology.

The present invention is not limited to the use of any particular hyperthermophilic organism. In some embodiments, mixtures of hyperthermophilic organisms are utilized. In some embodiments, the hyperthermophiles are from the archaeal order Thermococcales, including but not limited to hyperthermophiles of the genera Pyrococcus, Thermococcus, and Palaeococcus. Examples of particular organisms within these genera include, but are not limited to, Pyrococcus furiosus, Thermococcus barophilus, T. aggregans, T. aegaeicus, T. litoralis, T. alcaliphilus, T. sibiricus, T. atlanticus, T. siculi, T. pacificus, T. waiotapuensis, T. zilligi, T. guaymasensis, T. fumicolans, T. gorgonarius, T. celer, T. barossii, T. hydrothermalis, T acidaminovorans, T. profundus, T. stetteri, T. kodakaraenis, T peptonophilis. In some embodiments, aerobic hyperthermophilic organisms such as Aeropyrum pernix, Sulfolobus solfataricus, Metallosphaera sedula, Sulfolobus tokadaii, Sulfolobus shibatae, Thermoplasma acidophilum and Thermoplasma volcanium are utilized. While in other embodiments, anaerobic or facultative aerobic organisms such as Pyrobaculum calidifontis and Pyrobaculum oguniense are utilized. Other useful archaeal organisms include, but are not limited to, Sulfolobus acidocaldarius and Acidianus ambivalens. In some embodiments, the hyperthermophilic organisms are bacteria, such as Thermus aquaticus, Thermus thermophilus, Thermus flavus, Thermus ruber, Bacillus caldotenax, Geobacillus stearothermophilus, Anaerocellum thermophilus, Thermoactinomyces vulgaris, and members of the order Thermotogales, including, but not limited to Thermotoga elfeii, Thermotoga hypogea, Thermotoga maritima, Thermotoga neapolitana, Thermotoga subterranean, Thermotoga thermarum, Petrotoga miotherma, Petrotoga mobilis, Thermosipho africanus, Thermosipho melanesiensis, Fervidobacterium islandicum, Fervidobacterium nodosum, Fervidobacterium pennavorans, Fervidobacterium gondwanense, Geotogapetraea, Geotoga subterranea. In some preferred embodiments, the microorganism preferably has the characteristics of Thermotoga strain MH-1, Accession No. DSM 22925 or Thermotoga strain MH-2, Accession No. DSM 22926.

In some embodiments, hyperthermophilic strains of the above organisms suitable for fermenting biomass will be selected by screening and selecting for suitable strains. In still further embodiments, suitable strains will be genetically modified to include desirable metabolic enzymes, including, but not limited to hydrolytic enzymes, proteases, alcohol dehydrogenase, and pyruvate decarboxylase. See, e.g., (Brau B., and H. Sahm [1986] Arch. Microbiol. 146:105-110; Brau, B. and H. Sahm [1986] Arch. Microbiol. 144:296-301; Conway, T., Y. A. Osman, J. I. Konnan, E. M. Hoffmann, and L. O. Ingram [1987] J. Bacteriol. 169:949-954; Conway, T., G. W. Sewell, Y. A. Osman, and L. O. Ingram [1987] J. Bacteriol. 169:2591-2597; Neale, A. D., R. K. Scopes, R. E. H. Wettenhall, and N. J. Hoogenraad [1987] Nucleic Acid. Res. 15:1753-1761; Ingram, L. O., and T. Conway [1988] Appl. Environ. Microbiol. 54:397-404; Ingram, L. O., T. Conway, D. P. Clark, G. W. Sewell, and J. F. Preston [1987] Appl. Environ. Microbiol. 53:2420-2425). In some embodiments, the strains express enzymes that increase the production efficiency for single cell protein.

C. Degradation and Energy Production

In preferred embodiments of the present invention, one or more populations of hyperthermophilic organisms are utilized to degrade biomass or pretreated biomasses described above. In some embodiments, the biomass is transferred to a vessel such as a bioreactor and inoculated with one or more strains of hyperthermophilic organisms. In some embodiments, the environment of the vessel is maintained at a temperature, pressure, redox potential, and pH sufficient to allow the strain(s) to metabolize the feedstock. In some preferred embodiments, the environment has no added sulfur or inorganic sulfide salts or is treated to remove or neutralize such compounds. In other, embodiments, reducing agents, including sulfur containing compounds, are added to the initial culture so that the redox potential of the culture is lowered. In some preferred embodiments, the environment is maintained at a temperature above 45° C. In still further embodiments, the environment is maintained at between 55 and 90° C. In still further embodiments, the culture is maintained at from about 80° C. to about 110° C. depending on the hyperthermophilic organism utilized. In some preferred embodiments, sugars, starches, xylans, celluloses, oils, petroleums, bitumens, amino acids, long-chain fatty acids, proteins, or combinations thereof, are added to the biomass. In some embodiments, water is added to the biomass to form an at least a partially aqueous medium. In some embodiments, the aqueous medium has a dissolved oxygen gas concentration of between about 0.2 mg/liter and 2.8 mg/liter. In some embodiments, the environment is maintained at a pH of between approximately 3 and 11. In some embodiments, the environment is preconditioned with an inert gas selected from a group consisting of nitrogen, carbon dioxide, helium, neon, argon, krypton, xenon, and combinations thereof. While in other embodiments, oxygen is added to the environment to support aerobic degradation.

In other embodiments, the culture is maintained under anaerobic conditions. In some embodiments, the redox potential of the culture is maintained at from about −125 mV to −850 mV, and preferably below about −500 mV. In some embodiments, the redox potential is maintained at a level so that when a biomass substrate containing oxygen is added to an anaerobic culture, any oxygen in the biomass is reduced thus removing the oxygen from the culture so that anaerobic conditions are maintained.

The present invention is not limited to the use of any particular fermentation system or reactor. Indeed, fermentation with the hyperthermophilic organisms may be performed, for example, in a slurry fermentation system, moving bed bioreactors (e.g., where growth as a biofilm is preferable), and solid state fermentations systems utilized percolation.

In still other preferred embodiments, the biomass is supplemented with minerals, energy sources or other organic substances. Examples of minerals include, but are not limited, to those found in seawater such as NaCl, MgSO₄×7H₂O, MgCl₂×6H₂O, CaCl₂)×₂H₂O, KCl, NaBr, H₃BO₃, SrCl₂×6H₂O and KI and other minerals such as MnSO₄×H₂O, FeSO₄×7H₂O, CoSO₄×7H₂O, ZnSO₄×7H₂O, CuSO₄×5H₂O, KAl(SO₄)₂×12H₂O, Na₂MoO₄×2 H₂O, (NH₄)₂Ni(SO₄)₂×6 H₂O, Na₂WO₄×2 H₂O and Na₂SeO₄. Examples of energy sources and other substrates include, but are not limited to, purified sucrose, fructose, glucose, starch, peptone, yeast extract, amino acids, nucleotides, nucleosides, and other components commonly included in cell culture media.

It is contemplated that degradation of the biomass will both directly produce energy in the form of heat (i.e., the culture is exothermic or heat-generating) as well as produce products that can be used in subsequent processes, including the production of energy. In some embodiments, hydrogen, methane, and ethanol are produced by the degradation and utilized for energy production. In preferred embodiments, these products are removed from the vessel. It is contemplated that removal of these materials in the gas phase will be facilitated by the high temperature in the culture vessel. These products may be converted into energy by standard processes including combustion and/or formation of steam to drive steam turbines or generators. In some embodiments, the hydrogen is utilized in fuel cells. In some embodiments, proteins, acids and glycerol are formed which can be purified for other uses or, for example, used as animal feeds.

In some embodiments, the culture is maintained so as to maximize hydrogen production. In some embodiments, the culture is maintained under anaerobic conditions and the population of microorganisms is maintained in the stationary phase. Stationary phase conditions represent a growth state in which, after the logarithmic growth phase, the rate of cell division and the one of cell death are in equilibrium, thus a constant concentration of microorganisms is maintained in the vessel.

In some embodiments, the degradation products are removed from the vessel. It is contemplated that the high temperatures at which the degradation can be conducted facilitate removal of valuable degradation products from the vessel in the gas phase. In some embodiments, methane, hydrogen and/or ethanol are removed from the vessel. In some embodiments, these materials are moved from the vessel via a system of pipes so that the product can be used to generate power or electricity. For example, in some embodiments, methane or ethanol are used in a combustion unit to generate power or electricity. In some embodiments, steam power is generated via a steam turbine or generator. In some embodiments, the products are packages for use. For example, the ethanol, methane or hydrogen can be packaged in tanks or tankers and transported to a site remote from the fermenting vessel. In other embodiments, the products are fed into a pipeline system.

In still other embodiments, heat generated in the vessel is utilized. In some embodiments, the heat generated is utilized in radiant system where a liquid is heated and then circulated via pipes or tubes in an area requiring heating. In some embodiments, the heat is utilized in a heat pump system. In still other embodiments, the heat is utilized to produce electricity via a thermocouple. In some embodiments, the electricity produced is used to generate hydrogen via an electrolysis reaction.

In other preferred embodiments, the excess heat generated by the fermentation process is used to generate electricity in an Organic Rankine Cycle (ORC). A Rankine cycle is a thermodynamic cycle which converts heat into work. The heat is supplied externally to a closed loop, which usually uses water as the working fluid to drive a turbine coupled to the system. Conventional Rankine cycle processes generate about 80% of all electric power used in America and throughout the world, including virtually all solar thermal, biomass, coal and nuclear power plants. The organic Rankine cycle (ORC) uses an organic fluid such as pentane or butane in place of water and steam. This allows use of lower-temperature heat sources, which typically operate at around 70-90° C.

In other preferred embodiments, the present invention provides a process in which biomass is treated in two or more stages with hyperthermophilic organisms. In some embodiments, the process comprise a first stage where a first hyperthermophilic organism is used to treat a biomass substrate, and a second stage where a second hyperthermophilic organism is used to treat the material produced from the first stage. Additional hyperthermophilic degradation stages can be included. In some embodiments, the first stage utilizes Pyroccoccus furiosus, while the second stage utilizes Thermotoga maritima. In some preferred embodiments, the material produced from the second stage, including acetate, is further utilized as a substrate for methane production as described in more detail below.

In some embodiments, H₂ and/or CO₂ produced during hyperthermophilic degradation of a biomass are combined with methane from a biogas facility to provide a combustible gas. In some embodiments, H₂ and/or CO₂ producing during hyperthermophilic degradation of a biomass are added to a biogas reactor to increase production of methane. In other embodiments, the H₂ produced is used to generate heat that is utilized in the pretreatment step described above.

The present invention also provides systems, compositions and processes for degrading biomass under improved conditions. In some embodiments, a hyperthermophile strain derived from a marine hyperthermophile is utilized and the biomass is provided in a liquid medium that comprises less than about 0.2% NaCl. In some embodiments, the NaCl concentration ranges from about 0.05% to about 0.2%, preferably about 0.1% to about 0.2%. In some embodiments, the preferred strain is MH-2 (Accession No. DSM 22926). In these embodiments, the biomass is suspended in a liquid medium so that it can be pumped into a bioreactor system. It is contemplated that the lower salt concentration allows use of the residue left after degradation for a wider variety of uses and also results in less corrosion of equipment. Furthermore, the lower salt concentration allows for direct introduction of the degraded biomass containing acetate, or liquid medium containing acetate that is derived from the hyperthermophilic degradation, into a biogas reactor.

In further embodiments, the processes and microorganisms described herein facilitate degradation of biomass using concentrations of hyperthermophilic organisms that have not been previously described. In some embodiments, the concentration of the hyperthermophilic organism in the bioreactor is greater than about 10⁸ cells/ml. In some embodiments, the cell concentration ranges from about 10⁸ cells/ml to about 10¹¹ cells/ml, preferably from about 10⁹ cells/ml to about 10¹⁰ cells/ml.

In still further embodiments, the present invention provides processes that substantially decrease the hydraulic retention time of a given amount of biomass in a reactor. Hydraulic retention time is a measure of the average length of time that a soluble compound, in this case biomass suspended or mixed in a liquid medium, remains in a constructed reactor and is presented in hours or days. In some embodiments, the hydraulic retention time of biomass material input into a bioreactor in a process of the present invention is less than about 10 hours, preferably less than about 5 hours, more preferably less than about 4 hours, and most preferably less than about 3 or 2 hours. In some embodiments, the hydraulic retention time in a hyperthermophilic degradation process of the present invention is from about 1 to about 10 hours, preferably from about 1 to 5 hours, and most preferably from about 2 to 4 hours.

D. Utilization of Acetate

As described in the examples, one of the main products of fermentation with the hyperthermophilic organisms is acetate. The present invention provides novel processes for utilizing acetate to produce energy.

In some embodiments, acetate produced by fermentation with hyperthermophilic organisms is used for the production of methane or biogas. In these embodiments, the acetate, preferably contained in liquid fermentation broth, is introduced into a bioreactor containing methanogenic microorganisms. Examples of methanogens that are useful in bioreactors of the present invention include, but are not limited to, Methanosaeta sp. and Methanosarcina sp. The methane produced by this process can subsequently be used to produce electricity or heat by known methods.

The use of a wide variety of bioreactors, also known as biodigesters, is contemplated. Examples include, but are not limited to, floating drum digesters, fixed dome digesters, Deenbandhu digesters, bag digesters, plug flow digesters, anaerobic filters, upflow anaerobic sludge blankets, and pit storage digestors. Full-scale plants that are suitable for use in the present invention can be purchased from providers such as Viessman Group, DE. These systems may be modified to accept introduction acetate from the hyperthermophilic bioreactors of the present invention. In some preferred embodiments, the methanogen bioreactor is in fluid communication with the hyperthermophilic bioreactor. In some embodiments, the liquid fermentation broth from the hyperthermophilic bioreactor contains acetate and is delivered to the methanogen bioreactor. Preferably, the bioreactors are in fluid communication, but in alternative embodiments, the acetate-containing substrate may be delivered via tanker or other means.

In some embodiments, biomass, such as a pretreated biomass, is input into a bioreactor containing hyperthermophilic microorganisms. The biomass is preferably provided in a liquid medium. In some embodiments, the biomass has been previously degraded by microorganisms (e.g., the biomass may be the residue from a biogas reactor as depicted), biomass that has not been previously degraded or fermented by a biological process, or a mixture of the two. Degradation products from the hyperthermophilic bioreactor include H₂ and acetate. In some embodiments, acetate from the hyperthermophilic reactor is introduced into the biogas reactor. In some embodiments, the acetate is at least partially separated from the biomass residue in the hyperthermophilic reactor. In some embodiments, an aqueous solution comprising the acetate is introduced into the biogas reactor. In other embodiments, a slurry comprising the biomass residue and acetate is introduced into the biogas reactor. In some embodiments, the aqueous solution or slurry are pumped from the hyperthermophilic reactor into the biogas reactor. As described above, in some preferred embodiments, the aqueous solution or slurry have a NaCl concentration of less than about 0.2%. In some embodiments, H₂ is removed from the system, while in other embodiments, H₂ and other products including CO₂, are introduced into the biogas reactor. In some embodiments, the systems include a heat transfer system, such as the Organic Rankine Cycle. It is contemplated that production of acetate by degradation of biomass with hyperthermophilic microorganisms either before or after biogas production an increase the efficiency of use of a biomass material as compared to known biogas processes.

In some embodiments, acetate, CO₂ and/or other degradation products produced by fermentation with hyperthermophilic organisms are used for the culture of algae. In these embodiments, the degradation products (e.g., acetate), preferably contained in liquid fermentation broth, is introduced into a culture system for the production of algae. In some embodiments, the liquid fermentation broth from the hyperthermophilic bioreactor contains acetate and is delivered to the algae culture system. Preferably, the bioreactor and culture system are in fluid communication, but in alternative embodiments, the acetate-containing substrate may be delivered via tanker or other means. In preferred embodiments, algae grown is processed for the production of fatty acids which are then converted into biodiesel. A variety of methods are known in the art for accomplishing this conversion and for producing biodiesel and other energy substrates from algae.

Any suitable species of algae or prokaryotic cyanobacteria may be used in the present invention. In preferred embodiments, the algae is a microalgae, for example, a diatom (Bacillariophyceae), green algae (Chlorophyceae), or golden algae (Chrysophyceae). The algae may preferably grow in fresh or saline water. In some preferred embodiments, microalgae from one or more of the following genera are utilized: Oscillatoria, Chlorococcum, Synechococcus, Amphora, Nannochloris, Chlorella, Nitzschia, Oocystis, Ankistrodesmus, Isochrysis, Dunaliella, Botryococcus, and Chaetocerus.

In some embodiments, the acetate produced from the hyperthermophilic fermentation is used in a subsequent fermentation by purple nonsulfur bacteria (PNSB) for the production of additional biohydrogen. Suitable strains of suitable PNSB include, but are not limited to, Rhodospirillum rubrum, Rhodobacter sphaeroides and Rhodopseudomonas palustris.

E. Protein Production

In some embodiments, the fermentation of a biomass leads to the production of a high quality, consumable protein from waste biomass sources that have low levels of protein, poor quality protein, or which are contaminated with pathogens. Examples of the biomass sources include, but are not limited, to those described in detail above. In some particularly preferred embodiments, the biomass is fish sludge.

In some embodiments, the present invention provides a protein composition produced by the culture of hyperthermophilic organisms on a biomass, wherein the protein composition is suitable for oral consumption and thus for use as a feed source for humans and other animals, including, but not limited to, livestock such as cattle, sheep, pigs, goats, horses, chickens, ducks, geese and other domestic livestock, companion animals such as dogs and cats, fresh water and marine organisms such as fish and shrimp, and invertebrates such as worms and fly larvae. In some preferred embodiments, the single cell protein concentrate is a hyperthermophilic organism single cell protein. In some embodiments, the single cell protein of the present invention consists essentially of, or consists of, hyperthermophilic organisms. In some embodiments, the single cell protein is substantially free of cells of non-hyperthermophilic organisms. In some embodiments, the single cell protein concentrates are characterized in having a protein content on a weight/weight basis (e.g., dry or wet weight of protein per the total dry or set weight of the single cell protein composition or starting biomass material) of from about 5% to 100% higher, preferably from about 10% to 50% higher, than the protein content of the starting biomass material. In some embodiments, the single cell protein of the present invention are substantially free of living or active pathogenic organisms, e.g., human pathogenic organisms or domestic animal pathogenic organisms.

In some embodiments, the present invention provides a protein composition such as an enriched protein biomass that comprises the hyperthermophilic organisms and protein from the biomass on which the hyperthermophilic organisms are cultured. For example, when the biomass if fish sludge, the protein composition will comprise protein from hyperthermophilic organisms that are grown on the biomass and from the original biomass itself. It is contemplated that the fermentation process hygienizes the biomass so that the resulting protein composition is substantially free of living or active pathogens. In some embodiments, the protein compositions comprise DNA from the hyperthermophilic organisms utilized in the fermentation process as well as DNA from the biomass utilized in the process. In some preferred embodiments, the protein composition resulting from the process comprises approximately 70 to 95% protein from the biomass and approximately 5 to 30% protein from the hyperthermophilic organisms on a w/w basis (i.e., percent of total protein). In some embodiments where the fish sludge is a marine fish sludge, the protein composition will comprise from about 0.5 to 4% NaCl on a dry weight basis. In some preferred embodiments, the protein composition resulting from the process comprises approximately 5 to 30% protein from the biomass and approximately 70 to 95% protein from the hyperthermophilic organisms on a w/w basis. In some preferred embodiments, the protein composition resulting from the process comprises approximately 50% protein from the biomass and approximately 50% protein from the hyperthermophilic organisms on a w/w basis.

In some embodiments, the protein compositions of the present invention are produced from the water phase resulting from the hyperthermophilic fermentation step. In some embodiments, the protein within the water phase is concentrated by coagulation and/or flocculation to provide the protein composition. In preferred embodiments, chemical coagulation is utilized as the initial step in protein recovery to provide the protein composition. Suitable coagulants include, but are not limited to, alum, lime, synthetic polyelectrolytes, and natural polyelectrolytes, e.g., chitosan or carboxymethyl cellulose (cmc). In some embodiments, separation of the floc is accomplished by flotation or sedimentation. A process developed by the Microfloc Corporation involves the addition of alum and a polyelectrolyte. The coagulated mixture is directly applied to a mixed media separation bed. The separation bed is made up of several materials of different specific gravity and particle size, resulting in a graded filter media from coarse to fine. The addition of coagulants and removal of the floc on mixed media separation beds eliminates the need for clarification tanks. In some embodiments, the flocculated material is dried following separation. The energy for the drying step may preferably be provided by hydrogen derived from the hyperthermophilic fermentation step.

In other embodiments, the protein within the water phase is concentrated by direct or indirect drying. When drying is utilized, the heat energy may be provided by use of the hydrogen produced during the hyperthermophilic fermentation step. In still other embodiments, the protein within the water phase is concentrated by spray drying. In other embodiments, the single cell protein within the water phase is concentrated by vacuum drying.

In some embodiments, where the acetate is utilized in a fermentation by PNSB, a single cell protein comprising PNSB may concentrated as described above and used as further described herein alone or in combination with the HTSCC described below.

F. Feeds and Feed Supplements

In some embodiments, the protein compositions described above are utilized to produce animal feeds and feed supplements as well as human food supplements.

In some embodiments, the protein compositions are combined with a protein source, carbohydrate source and/or fat and combinations thereof to produce an animal ration or feed supplement for oral consumption by the animal or human. In some embodiments, the protein source, carbohydrate source and/or fat and combinations thereof are from an organism (e.g., a plant, animal or microorganism) other than the hyperthermophilic organism contained in the protein compositions. In some embodiments, the animal feed is pelleted feed. In other embodiments, the protein compositions are used as a feed supplement or top dress that can be added to animal feed to increases the protein content of the feed.

In some embodiments, the protein compositions are first fed to an intermediate protein vector, e.g., fly larvae or worms. The protein vector (e.g., fly larvae or worms) may then be used to feed suitable animals such as fish, poultry or other domestic animals.

### EXAMPLES

### Example 1

This example provides data relating to culture of hyperthermophilic organisms on fish sludge.

The following fish sludge substrates were tested in small scale:

| Name | Form |
|---|---|
| BR - OBS | fine powder |
| SA - OBS | coarse-grained granules |
| MV - OBS | fine-grained granules |
| AQUA-6 - OBS | coarse-grained granules |
| SCAN - OBS | fine powder |

### Material for Large Scale Testing:

### BR (lot 2)

BR (lot 1, same as for small scale testing)

### Growth Tests:

1. Small scale tests in serum flasks

2. Fermentations
a. Batch fermentation with BR lot 2 at 5% and 10% in synthetic standard medium
b. Batch fermentation with BR lot 1 at 10%, 5% and 10% with an adapted culture in synthetic standard medium

### Tests Performed—Results

### 1. Small Scale Tests in Serum Flasks

### Material Tested:

| | | | Growth | Growth |
|---|---|---|---|---|
| Name | Form | Tested | MH1 | Lep110 |
| BR - OBS | fine powder (lot 1) | yes | yes | yes |
| SA - OBS | coarse-grained | yes | no | — |
| | granules | | | |
| MV - OBS | fine-grained granules | yes | no | no |
| AQUA-6 - OBS | coarse-grained | yes | no | no |
| | granules | | | |
| SCAN - OBS | fine powder | yes | no | no |

### Tests:

1.1. Serum flask test with MH1

1.2. Serum flask test with Lepl10

### Results:

1.1 Serum flask test with MH1:

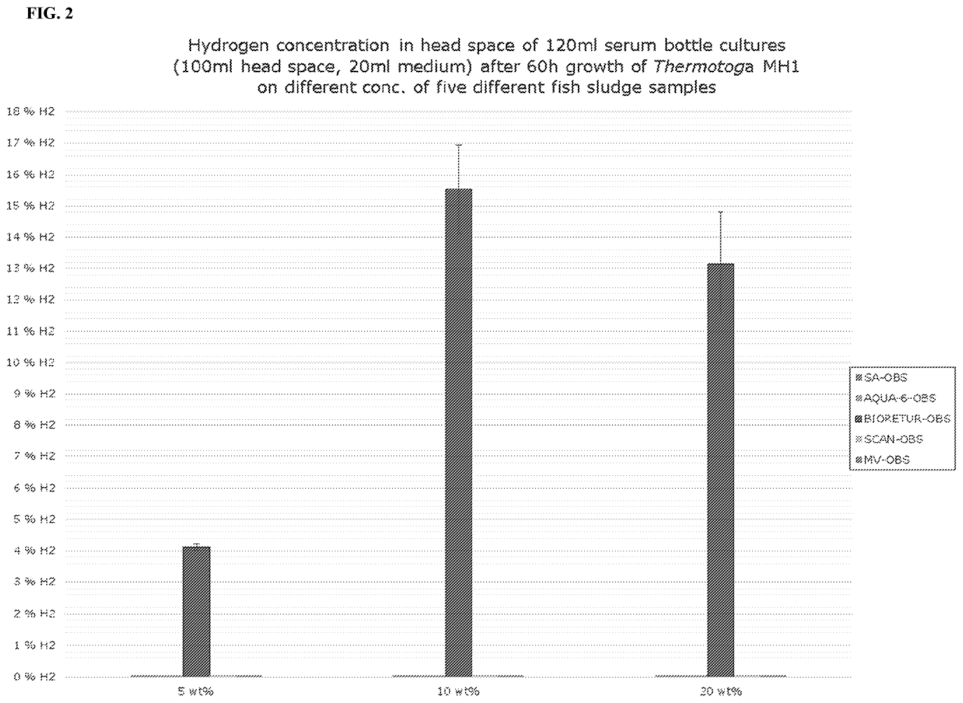

Thermotoga medium (MM1+Wolfe's minerals) (+0.05% yeast extract)+5%, 10% or 20% fish sludge material. Thermotoga MH1 grows very good on BR-OBS but not on the other materials tested. See FIG. 2.

1.2 Serum Flask Test with Lepl10:

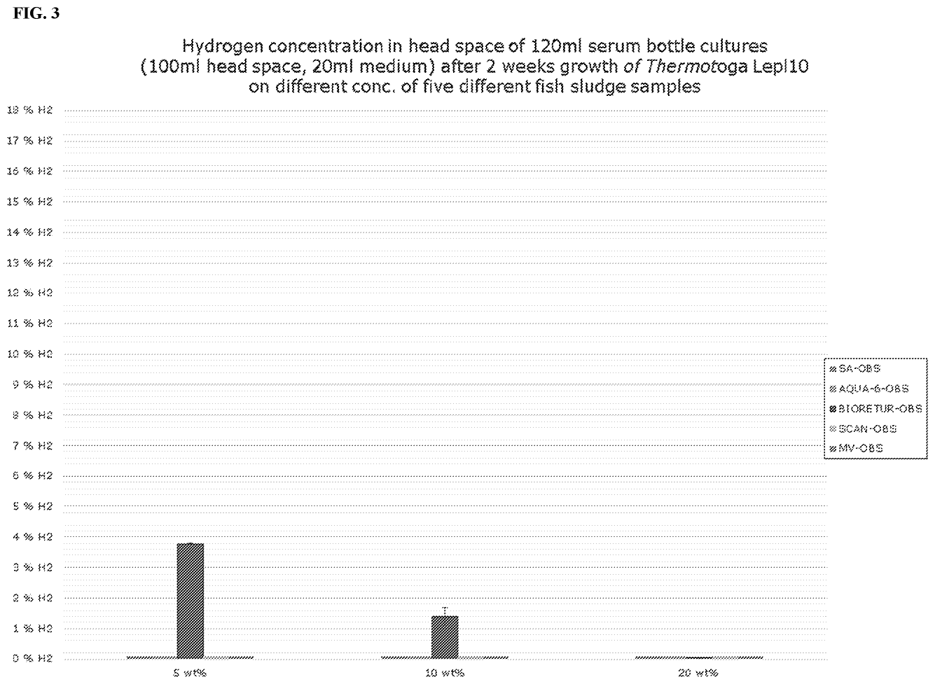

Thermotoga medium (MM1+Wolfe's minerals) (+0.05% yeast extract)+x % fish sludge material. Thermotoga Lepl10 grows very good on 5% BR-OBS (lot 1) but not on the other materials tested here. Hydrogen production on 5% BR is almost the same as with MH1, whereas the 10 and 20% results are surprisingly low. See FIG. 3.

2. Fermentation Tests with BR

2.1. Fermentation with 5% BR (Lot 2) in Standard Medium.

The reactor was filled with MMI medium (containing Wolfe's minerals, 0.05% YE), as a Carbon source 5% BR was added, the pH was adjusted from 5.5 to 5.8 by addition of Na₂S and from 5.8 to 6.5 by adding 2N NaOH, and the reactor was incubated at 80° C. and inoculated with Lepl10. As no growth was observed within 3 days, the reactor was also inoculated with MH1. ORP vs gas production and growth vs total gas production during growth were plotted (data not shown). Good bacterial growth on 5% BR (lot 2) was observed as indicated by the gas production. Gas composition was analyzed along with organic acid (lactate, acetate) production. The content of hydrogen reached 40% in the reactor.

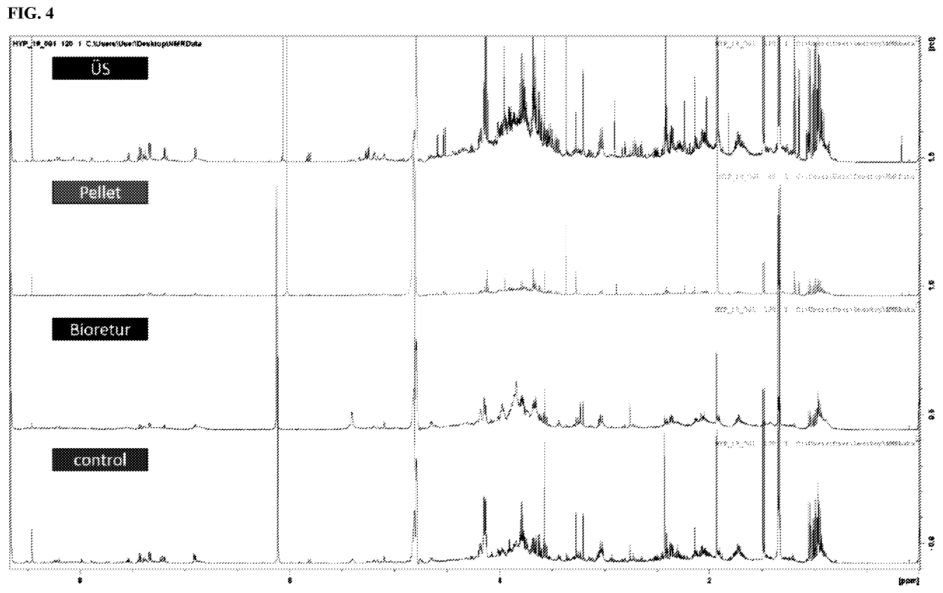

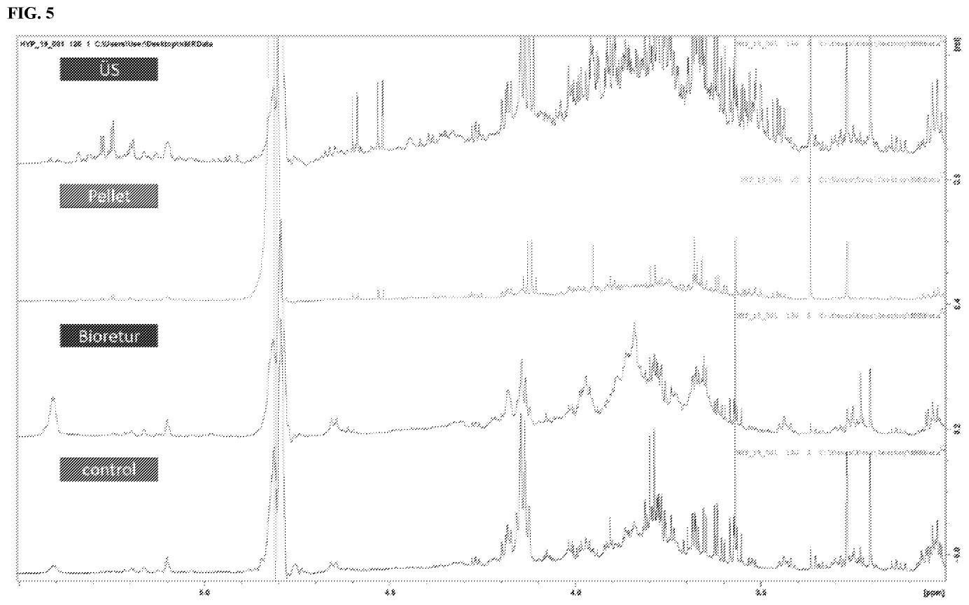

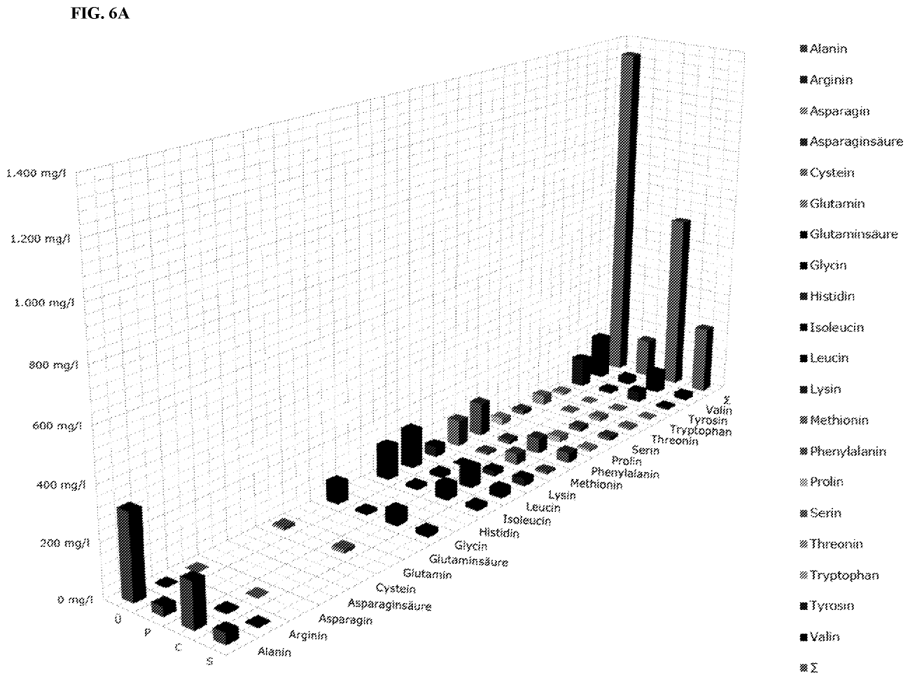

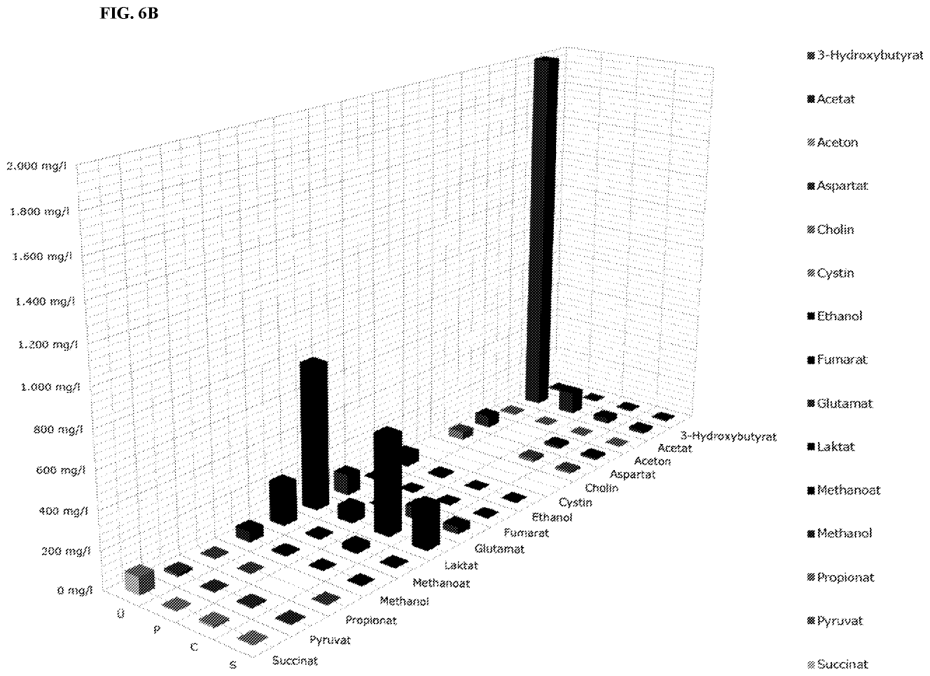

Samples were used for NMR analysis:
Fr190513ÜS (liquid part after fermentation) supernatant after fermentation and centrifugation
Fr190513Pellet (solid part after fermentation resuspended in MMI) pellet after fermentation and centrifugation
Fr190513control (5% in MMI) BR lot 2 (used for 1st 5% fermentation)
BR (5% in MMI) sample BR lot 1 (used for small scale testing) The data is provided in FIGS. 4 and 5. FIGS. 4 and 5 show a clear difference between ÜS and the other samples. BR (lot 1) and control BR (lot 2) differ. Anomeric protons are found in the region >5.0 ppm. Concentration of soluble carbohydrates to be estimated from the total intensity in the region of 3.4-4.4 ppm. Data on amino acid composition and metabolites is provided in FIGS. 6a and 6b. The protein content in supernatant is about 10× higher as in pellet. The difference between control and fermented sample is about 800 mg protein/1, which would correspond (and fit to the estimated) to the following cell densities: 2.8×10\hat{ }8 cells/ml (5 μm long cells) and 5.5×10\hat{ }8 cells/ml (4 μm long cells). The concentrations of some amino acids change:

### Alanine (2.1×)

### Isoleucine (2.5×)

### Leucine (2.1×)

### Lysine (2.2×)

### Methionine (2.7×)

### Phenylalanine (2.4×)

### Threonine (2.6×)

### Tyrosine (3.0×)

### Valine (2.3×)

These data indicate that Thermotoga is producing free amino acids by degradation of proteins. These amino acids will be taken up during growth.
2.2 Fermentations with 5% and 10% BR (Lot 1) in Standard Medium

The reactor was filled with MMI medium (containing Wolfe's minerals, 0.05% YE), as a Carbon source BR with the respective percentage was added, the pH was adjusted to 6.5 and the reactor was incubated at 80° C. Thermotoga used: Lepl 10 and MH1 (the impact of each strain cannot be analyzed)

| Fermentations performed | Comments |
|---|---|
| FR190624 10 wt % BR | First 10% fermentation to compare with |
| | lot 1 |
| FR190619 5 wt % BR | 5% fermentation to compare with lot 1 |
| FR190606 10 wt BR | Second 10% fermentation this time with |
| | an already adapted culture |

ORP vs gas production and growth vs total gas production during growth were plotted (data not shown). A significant increase of the gas production on 10% BR was visible using an adapted culture.

### NMR Analysis of the Metabolites:

| Samples taken | Comments |
|---|---|
| FR190624 10 wt % | FR190624_S0_UES details [24.06.2019-15:30] |
| BR - adapted culture | sample before inoculation |
| | FR190624_S1_UES details [25.06.2019-11:40] |
| | intermediate sample −> (2.5 × 10\hat{ }9 cells/ml, |
| | cells mostly in exponential growth stadium) |
| | FR190624_S2_UES details [25.06.2019-15:45] |
| | intermediate sample −> (1.8 × 10\hat{ }9 cells/ml, |
| | cells mostly in stationary stadium) |
| | FR190624_S3_UES details [26.06.2019-09:00] |
| | final sample −> no cell density determined |
| FR190619 5 wt % | FR190619 - S00 [19.06.2019-15:30] sample |
| BR | before inoculation |
| | FR190619 - S01 [21.06.2019-10:30] intermediate |
| | sample |
| | (3,4 × 10\hat{ }9 cells/ml [ca. 1/3 respectively 33% |
| | dividing cells] |
| | FR190619 - S02 [24.06.2019-09:20] final sample |
| | with increase liquid volume in the reactor due to |
| | some vacuum in the reactor after sampling S01 |
| FR190606 10 wt BR | FR190606 - S00 [06.06.2019-17:05] sample |
| | before inoculation |
| | FR190606 - S02 [19.06.2019-09:30] sample |
| | after fermentation stop |

Measurement: Samples were measure directly, without further modification. Therefore, it results in free amino acids and sugars only.

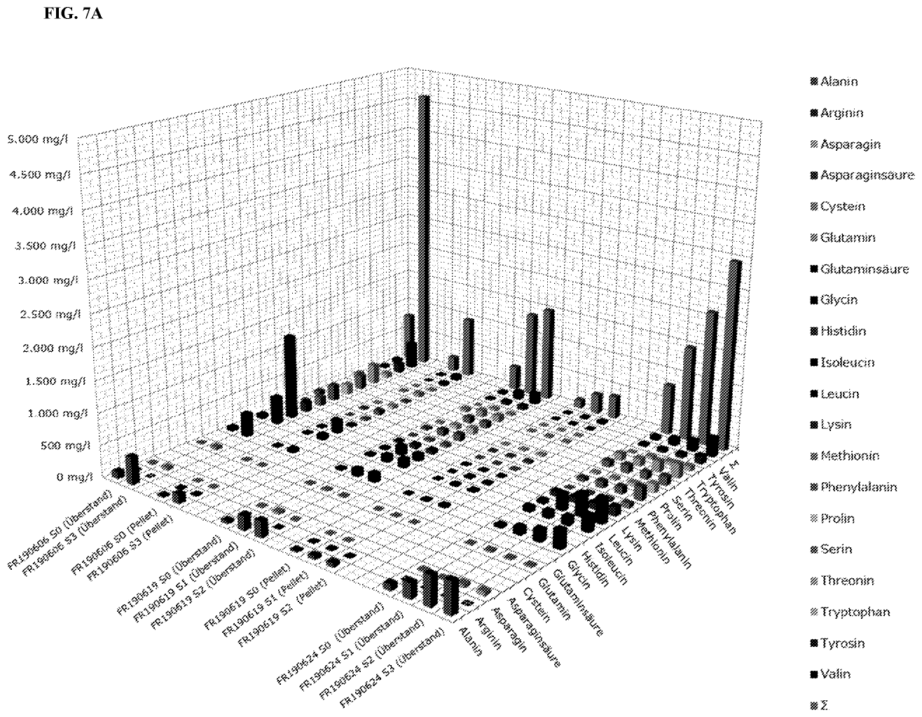

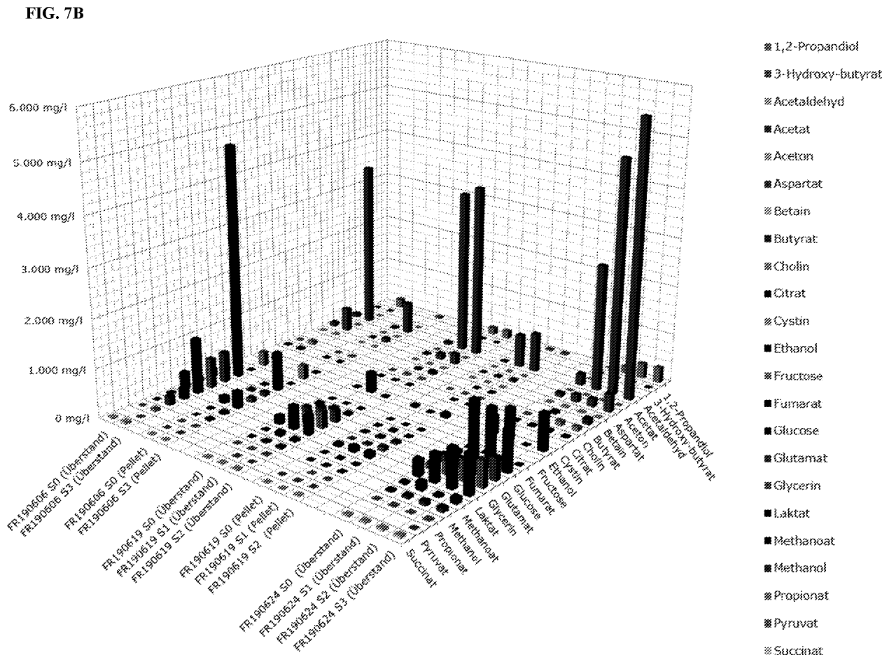

The data is provided in FIGS. 7A and 7B. The data show a large increase in amino acids and, e.g., acetate. This indicates degradation of proteins to grow new cells.

Protein concentration analysis via Bradford:

Samples taken
FR190624 10 wt % BR - adapted culture
FR190619 5 wt % BR
FR190606 10 wt BR

### FR190606 Lepl10+MH1 on 10% Fish Sludge Powder (BR 1st Batch)

| | |
|---|---|
| FR190606 - S00 start | 0,585 mg/ml |
| FR190606 - S02 end | 0,832 mg/ml |

[symbol]

significant increase in protein concentration

### FR190606 Lepl10+MH1 on 5% Fish Sludge Powder (BR 1st Batch)

| | |
|---|---|
| FR190619 - S00 | 0,356 mg/ml |
| FR190619 - S01 | 0,565 mg/ml |
| FR190619 - S02 | 0,594 mg/ml (measured: 0,424 mg/ml: calculating in |
| | the dilution in the reactor [symbol] 0,594 mg/ml) |

[symbol]

significant increase in protein concentration

### Summary:

| Experiment | FR190606 | | FR190619 | | FR190624 | |
|---|---|---|---|---|---|---|
| | | | | | (repetition of | |
| | | | | | FR190606) | |
| Substrate | 10 | wt % DM BR | 5 | wt % DM BR | 10 | wt % DM BR |
| | (2^{nd} lot) | | (2^{nd} lot) | | (2^{nd} lot) | |
| max. H₂ | 35 | ml [H2(0° C.)]/h | 253 | ml [H2(0° C.)]/h | 461 | ml [H2(0° C.)]/h |
| production rate | 17 | ml | 126 | ml | 231 | ml |
| | [H2(0° C.)]/(l[culture]*h) | | [H2(0° C.)]/(l[culture]*h) | | [H2(0° C.)]/(l[culture]*h) | |
| | 0,8 | mmol | 5,6 | mmol | 10,3 | mmol |
| | [H2(0° C.)]/(l[culture]*h) | | [H2(0° C.)]/(l[culture]*h) | | [H2(0° C.)]/(l[culture]*h) | |
| total exhaust gas | 2.041 | ml [0° C.] | 7.483 | ml [0° C.] | 8.866 | ml [0° C.] |
| maximal exhaust | 65 | ml [0° C.]/h | 415 | ml [0° C.]/h | 811 | ml [0° C.] /h |
| gas production rate | | | | | | |
| (approximation) | | | | | | |
| total H₂ production | 1.091 | ml [0° C.] | 4.556 | ml [0° C.] | 5.043 | ml [0° C.] |
| (approximation) | 48,7 | mmol | 203,3 | mmol | 225,0 | mmol |
| initial acetate conc. | 2,9 | mM | 1,4 | mM | 5,2 | mM |
| (HPLC) | 173 | mg/1 | 86 | mg/1 | 310 | mg/1 |
| final acetate conc. | 38,5 | mM | 55,6 | mM | 63,2 | mM |
| (HPLC) | 2.313 | mg/l | 3.341 | mg/l | 3.797 | mg/1 |
| [corrected for | | | | | | |
| dilution | | | | | | |
| bias/distortion] | | | | | | |
| initial acetate conc. | 1,4 | mM | 1,0 | mM | 4,0 | mM |
| in supernatant | 83 | mg/1 | 62 | mg/1 | 240 | mg/1 |
| (NMR) | | | | | | |
| final acetate conc. | 61,2 | mM | 86,3 | mM | 105,8 | mM |
| in supernatant | 3.675 | mg/1 | 5.184 | mg/1 | 6.356 | mg/1 |
| (NMR) | | | | | | |
| [corrected for | | | | | | |
| dilution | | | | | | |
| bias/distortion] | | | | | | |

Very good H₂-yields were observed, especially after adaptation of the culture (i.e., selection of Lepl10 on the substrate). It is clear Thermotoga is building new cells and thus also new protein.

### Example 2

This example describes fermentation with fruit and vegetable substrates.

Fermentation was with 5%, or 10% or 20% equal mix of the following fruits and vegetables in standard medium. The substrate consists of an equal mix of the following fruits and vegetables (from a local supermarket): orange, carrot, tomato, cucumber, pear, and apple.

The fruits were bought and stored for 2.5-4 days at room temperature to allow start of decaying, to mimic a situation where they will be coming back from the stores. For the fermentation the fruits and vegetables were taken with equal amounts each and crushed in a blender (food processor).

The reactor was filled with MMI medium (containing Wolfe's minerals, 0.05% YE), as a Carbon source 5%, or 10% or 20% of an equal mix of the fruits and vegetables was added, the pH was adjusted if required by addition of Na₂S, which was also use to press the ORP below −250 and finally adjusted to 6.5 by adding 2N NaOH, and the reactor was incubated at 80° C. and inoculated with a mix of Lepl10 and MI. ORP vs gas production and growth vs total gas production during growth were plotted. Good bacterial growth on 5%, 10% and 20% of an equal mix of the fruits and vegetables was observed as indicated by the gas production. Gas composition (Hydrogen and CO₂) was analyzed along with organic acid (lactate, acetate) production.

Samples from 10% fermentation were used for NMR analysis:

FR190805 10% wet mass 3f+3v NO Protease K S0 (Pellet+SN)

FR190805 10% wet mass 3f+3v NO Protease K S1 (Pellet+SN)

### Abbreviations Used

3f+3v: equal mix of the 3 fruits and 3 vegetables

NO Protease K: Samples were not treated by protease K

S0: Sample taken at the beginning of the fermentation

S1: Sample taken at the end of the fermentation

Pellet+SN: Total sample, without centrifugation to separate pellet and supernatant

Substrate composition and results are shown below.

| FR190709 | FR190805 | FR190820 |
|---|---|---|
| 5.0 wt % 3 fruits + 3 vegetables | 10.0 wt % 3 fruits + 3 vegetables | 20.0 wt % 3 fruits + 3 vegetables |
| mix (wet mass) | mix (wet mass) | mix (wet mass) |
| 0.459 wt % 3 fruits + 3 vegetables | 0.913 wt % 3 fruits + 3 vegetables | 1.335 wt % 3 fruits + 3 vegetables |
| (dry mass) | (dry mass) | (dry mass) |
| total amount of organic | total amount of organic | total amount of organic |
| material (estimated) | material (estimated) | material (estimated) |
| 50.9 mM org. material | 101.8 mM org. material | 203.5 mM org. material |
| (glucolse equivalents) | (glucolse equivalents) | (glucolse equivalents) |
| theoretical H₂ yield | theoretical H₂ yield | theoretical H₂ yield |
| 203.5 mmol | 407.0 mmol | 814.1 mmol |
| 4,979 ml (25° C.; 101,325 Pa) | 9,958 ml (25° C.; 101,325 Pa) | 19,916 ml (25° C.; 101,325 Pa) |
| total exhaust gas (CO₂ + H₂) | total exhaust gas (CO₂ + H₂) | total exhaust gas (CO₂ + H₂) |

| | | | | | |
|---|---|---|---|---|---|
| 2,734 | ml | 4,966 | ml | 2,110 | ml |

| | | |
|---|---|---|
| total H₂ production [estimated | total H₂ production [estimated | total H₂ production [estimated |
| (2/3 H₂ +1/3 CO₂)] | (2/3 H₂ + 1/3 CO₂)] | (2/3 H₂ + 1/3 CO₂)] |

| | | | | | |
|---|---|---|---|---|---|
| 73.3 | mmol | 133.1 | mmol | 56.5 | mmol |
| 1,822.8 | ml | 3,310.7 | ml | 1,406.7 | ml |

| | | |
|---|---|---|
| estimated H₂ yield | estimated H₂ yield | estimated H₂ yield |
| 33.5% | 32.7% | 6.9 % |
| initial acetate concentration | initial acetate concentration | initial acetate concentration |

| | | | | | |
|---|---|---|---|---|---|
| 0.1 | mM | 0.2 | mM | 0.4 | mM |

| | | |
|---|---|---|
| final acetate concentration after | final acetate concentration after | final acetate concentration after |
| incubation | incubation | incubation |
| final acetate concentration after | final acetate concentration after | final acetate concentration after |
| fermentation (NMR) | fermentation (NMR) | fermentation (NMR) |

| | | | | | |
|---|---|---|---|---|---|
| 32.0 | mM | 54.6 | mM | 51.6 | mM |

| | | |
|---|---|---|
| abiotic acetate production | abiotic acetate production | abiotic acetate production |
| not determined | not determined | not determined |
| Theoretical acetate production by | Theoretical acetate production by | Theoretical acetate production by |
| Thermotoga | Thermotoga | Thermotoga |
| (50% of the max. H₂ prod. of | (50% of the max. H₂ prod. of | (50% of the max. H₂ prod. of |
| 2/3 of total exhaust gas) | 2/3 of total exhaust gas) | 2/3 of total exhaust gas) |

| | | | | | |
|---|---|---|---|---|---|
| 36.6 | mM (*) | 66.6 | mM (*) | 28.3 | mM |

(*) the discrepancy between the measured “final acetate concentration after fermentation (NMR)” and the “theoretical acetate production by Thermotoga” arises due to the fact that the theoretical value is calculated under the assumption that the exhaust gas is composed exclusively of 67% H2 and 33% CO2 which is the case when high cell densities are achieved. The fact that the latter (theoretical) value lies above the former (measured) one is an indication that the H2 concentration during fermentation did not achieve the above mentioned value of 67% but a lower one.

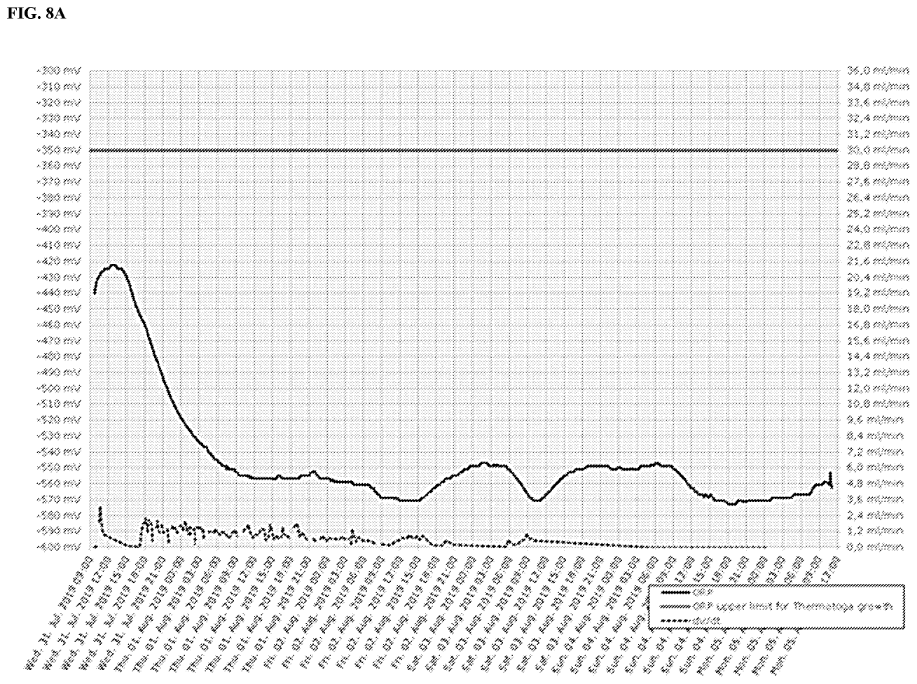

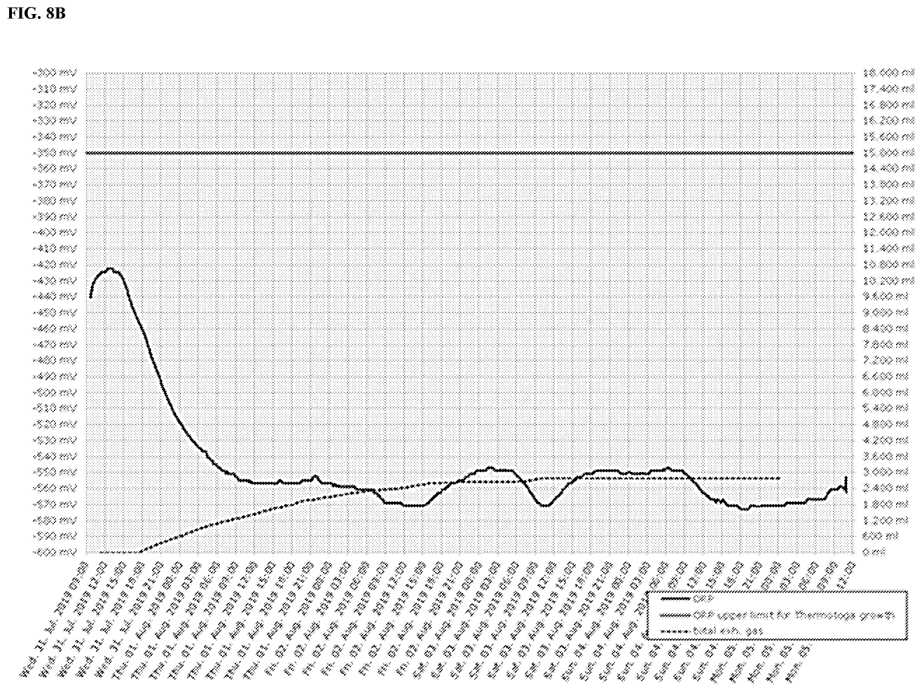

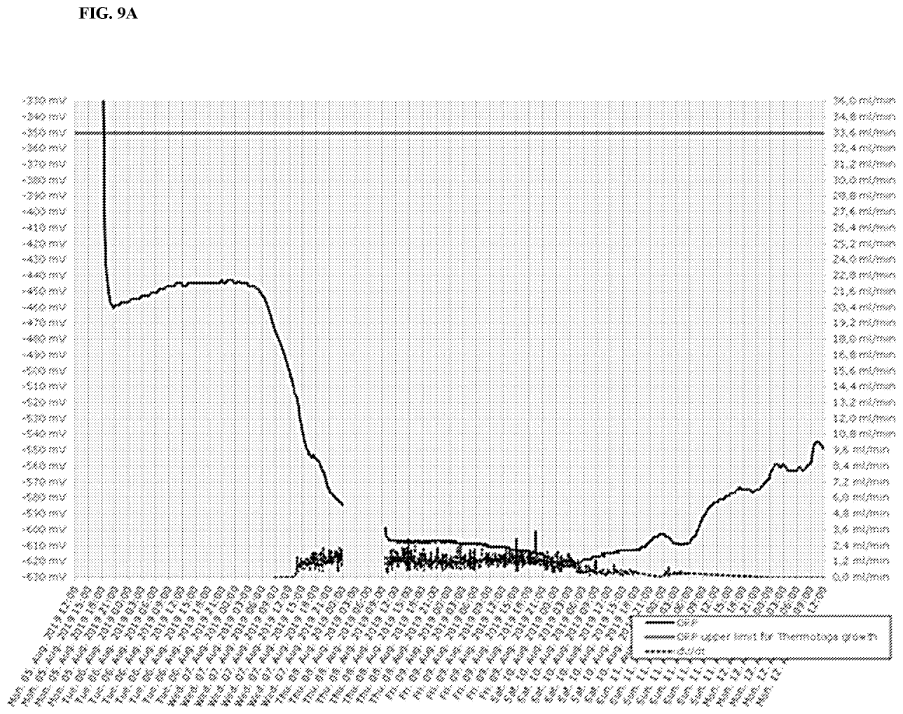

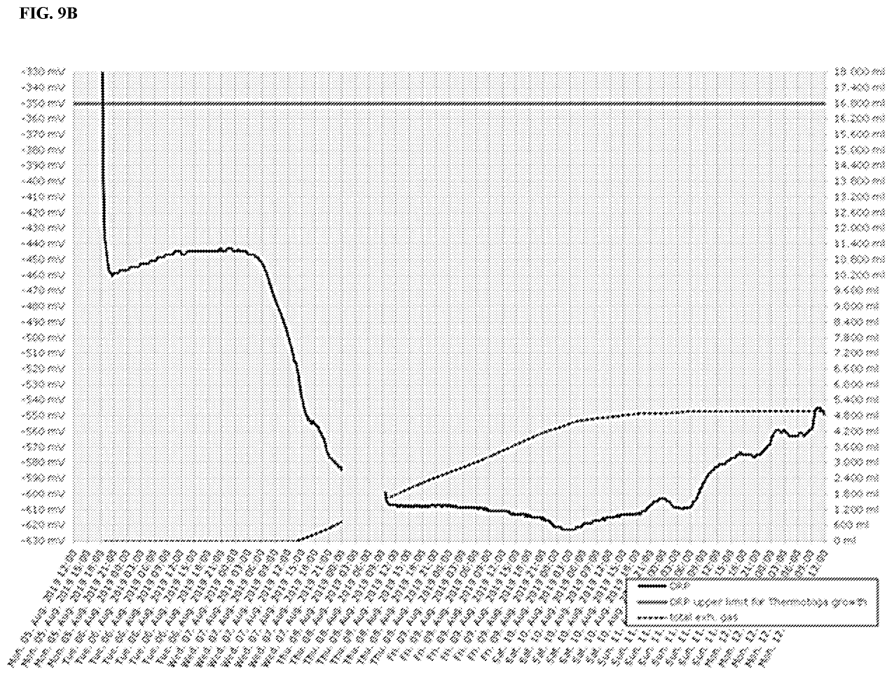

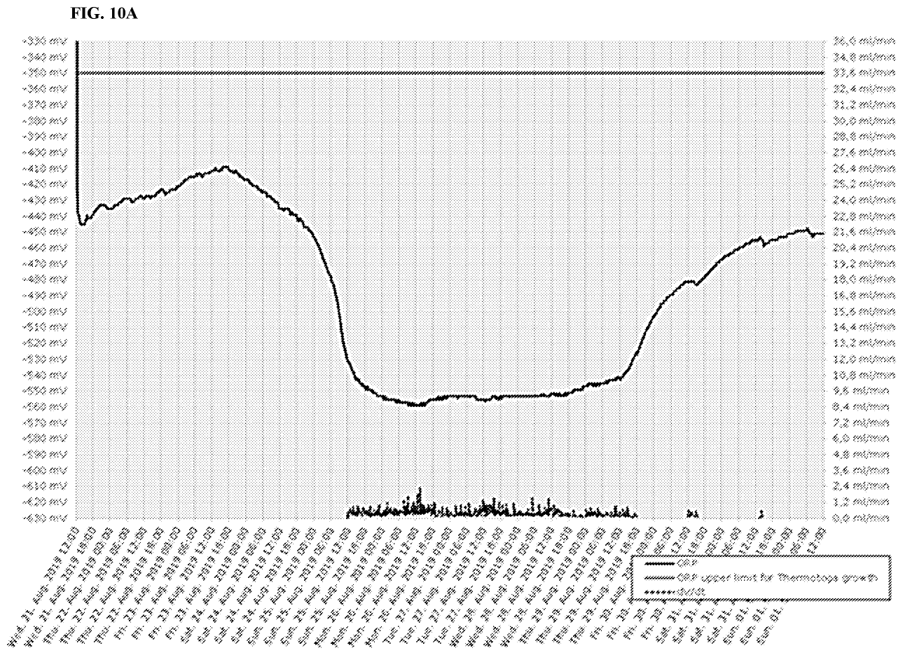

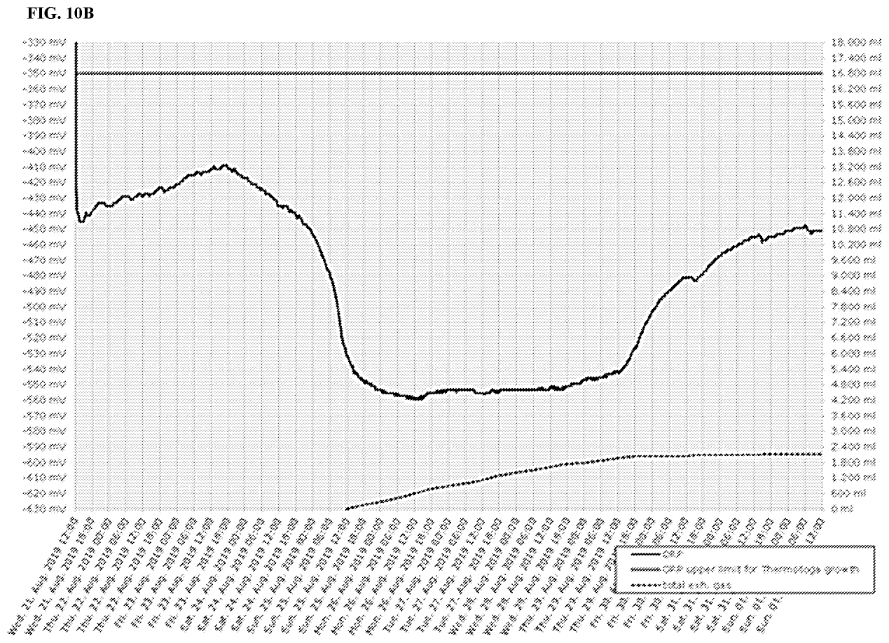

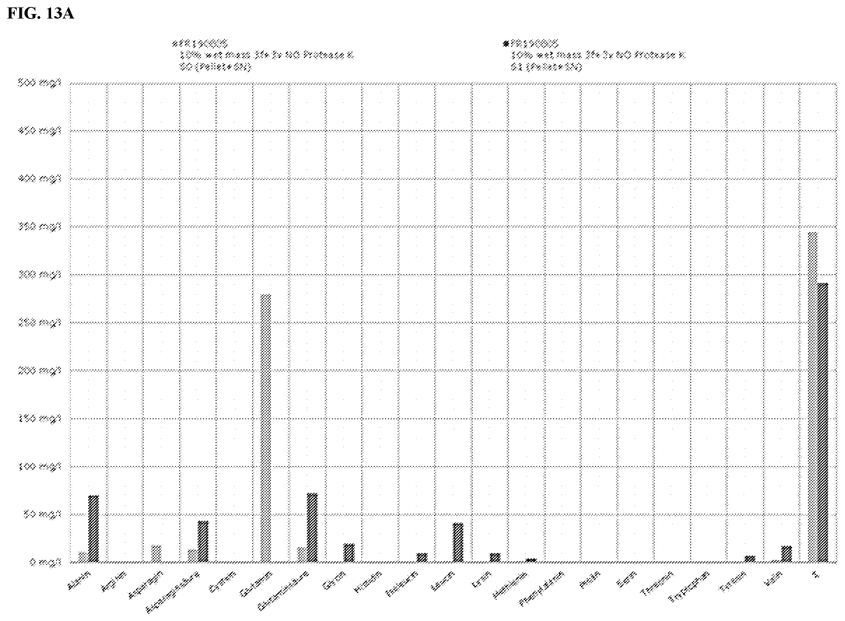

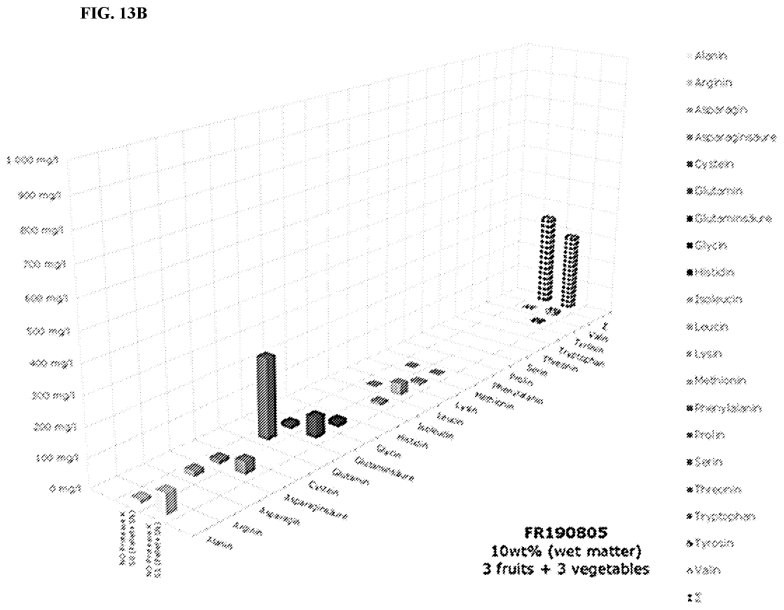

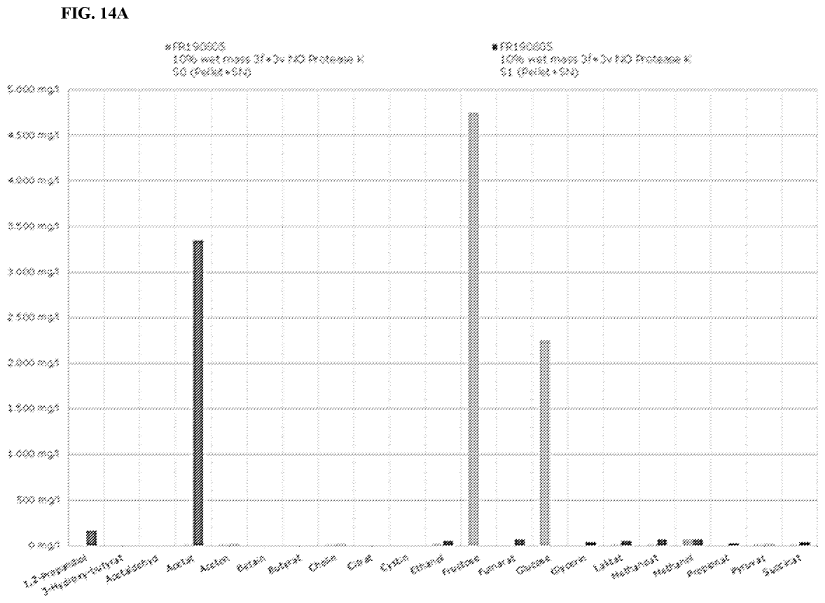

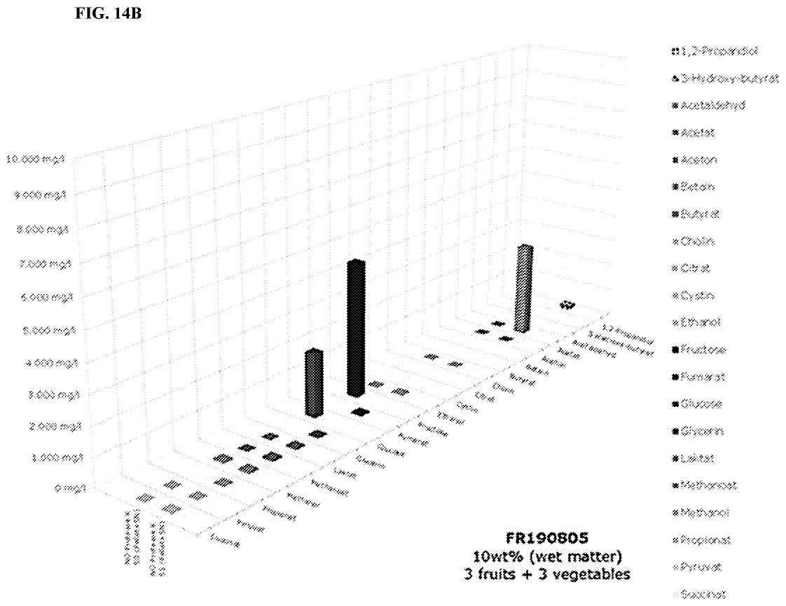

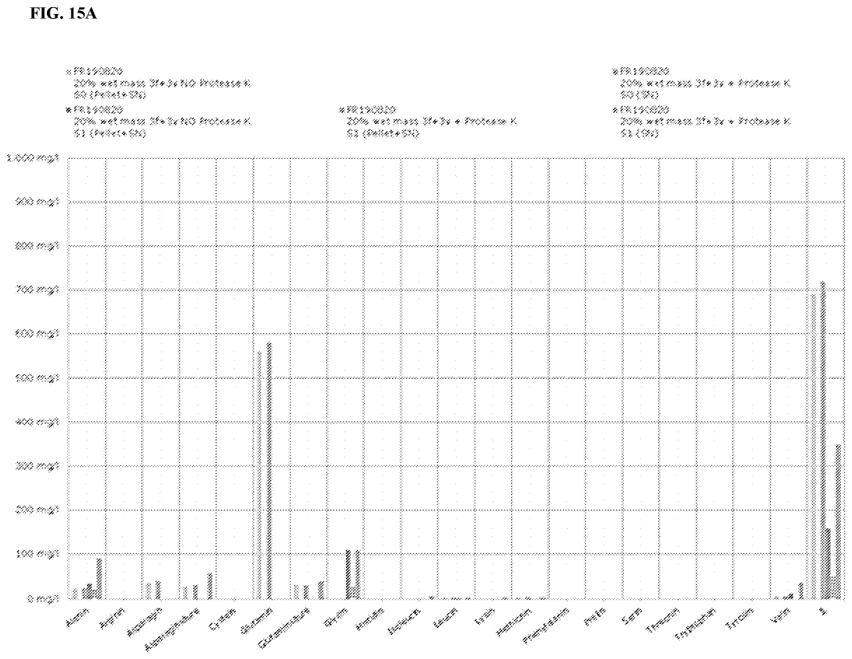

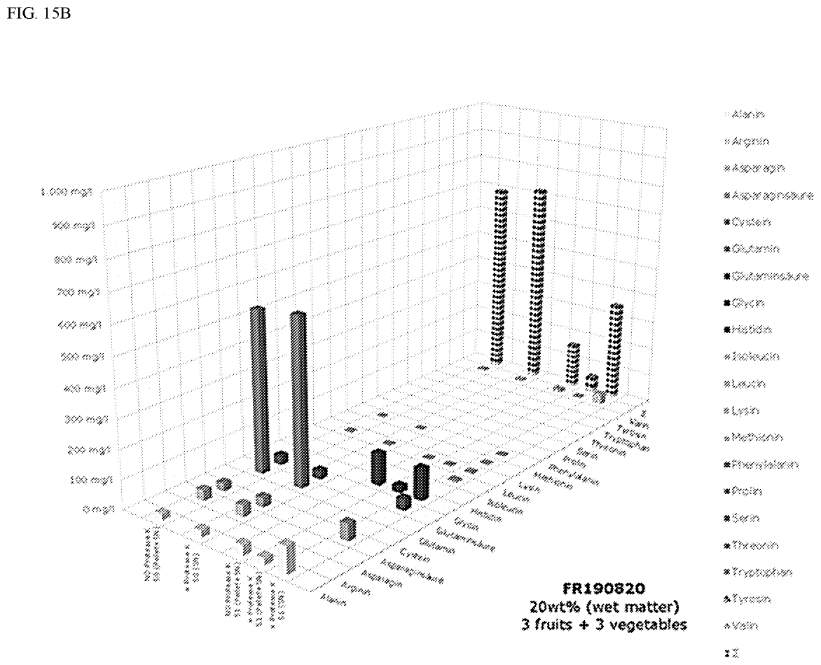

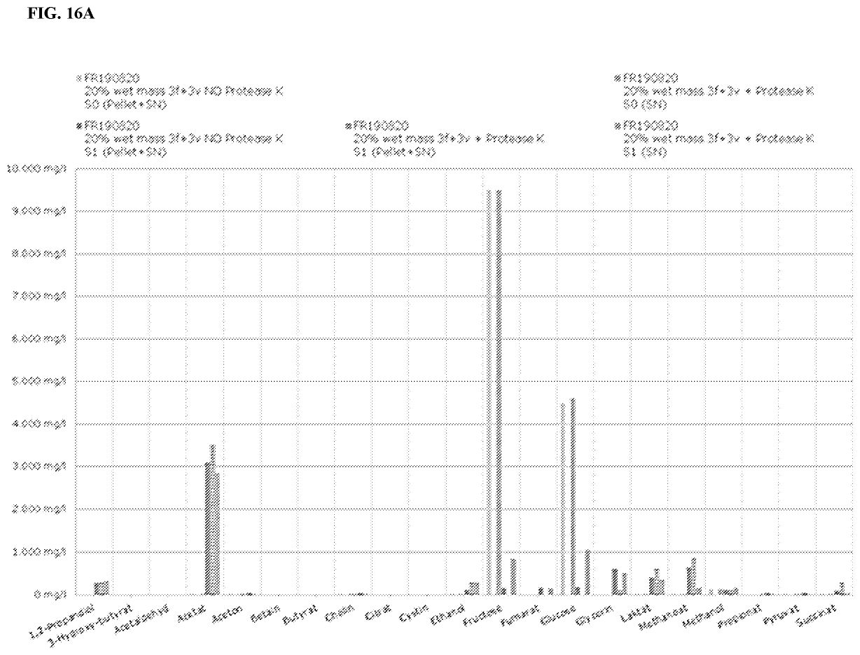

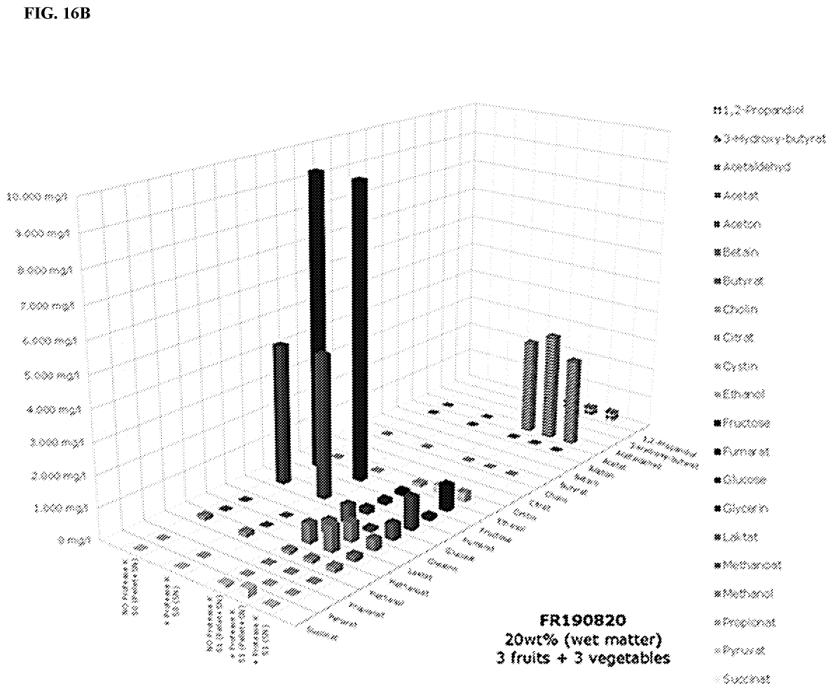

Further results are shown in FIGS. 8-16. FIG. 8 shows Thermotoga MH1/Lepl10 growth on 5% equal mix of fruits and vegetables. Growth vs gas production during growth (FIG. 8A); Growth vs total gas production during growth (FIG. 8B). FIG. 9 shows Thermotoga MH1/Lepl10 growth on 10% equal mix of fruits and vegetables. Growth vs gas production during growth (FIG. 9A); Growth vs total gas production during growth (FIG. 9B). FIG. 10 shows Thermotoga MH1/Lepl10 growth on 20% equal mix of fruits and vegetables. Growth vs gas production during growth (FIG. 10A); Growth vs total gas production during growth (FIG. 10B).

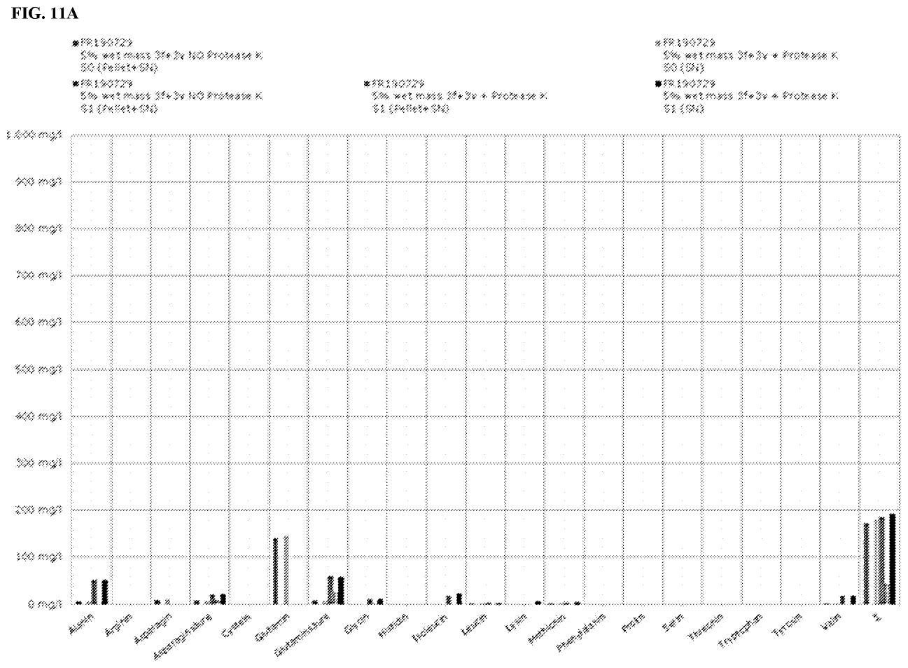

The concentrations of some amino acids like Alanin, Aspartate, Glutamate, Glycin, Lysin, Isoleucin, Tyrosin and Valin increase during fermentation, whereas Glutamine concentration is increasing (FIGS. 11, 13, and 15).

These data indicate that Thermotoga is producing free amino acids by degradation of proteins. These amino acids will be taken up during growth, probably with different rates.

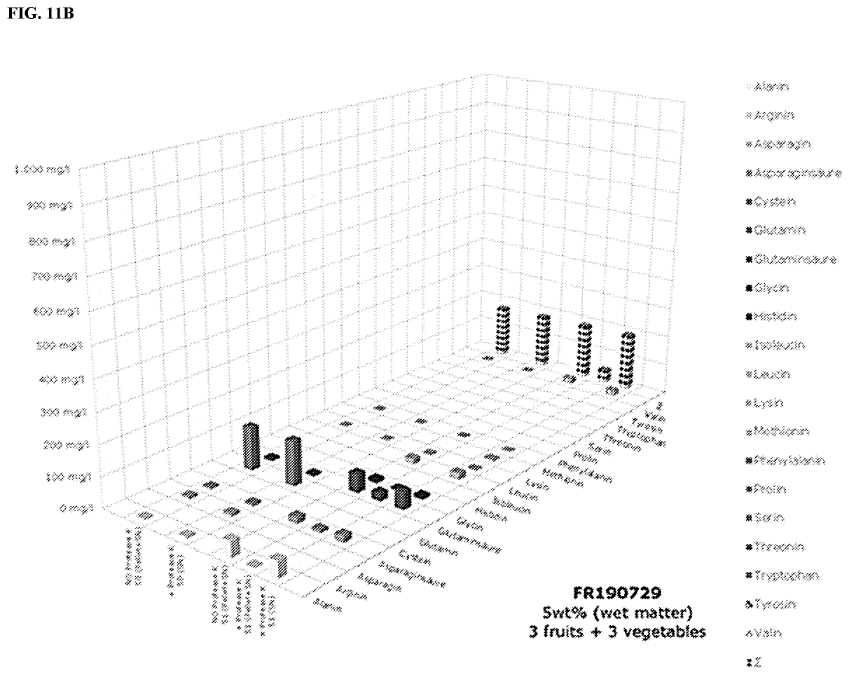

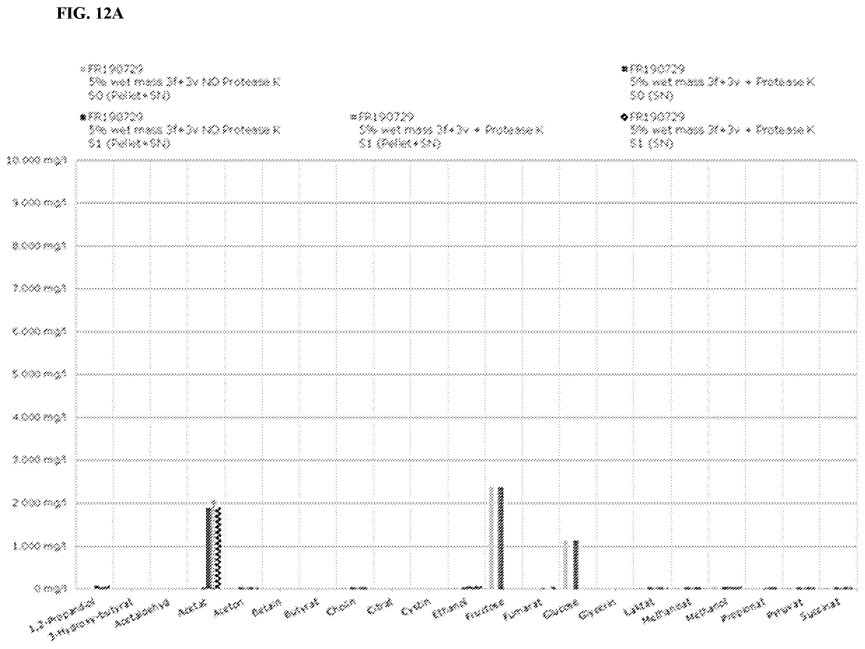

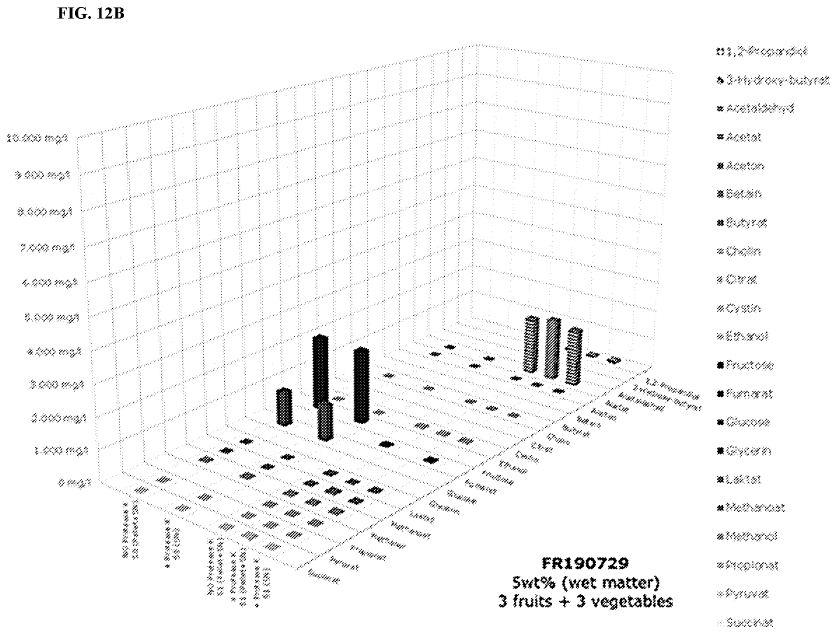

During fermentation fructose and glucose are consumed by Thermotoga, whereas mainly Acetate, but also other substances like 1,2-Propandiol, Ethanol etc. are produced (FIGS. 12, 14, and 16).

All publications and patents mentioned in the above specification are herein incorporated by reference. Various modifications and variations of the described method and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are obvious to those skilled in the relevant fields are intended to be within the scope of the following claims.

1. A protein composition comprising a hyperthermophilic organism single cell protein material, the protein powder having a total protein content of from about 5% to 99% on a dry w/w basis (weight of protein/total mass of composition).

2. The protein composition of claim 1, wherein the hyperthermophilic organism is selected from the group consisting of a member of Order Thermococcales, the Family Thermococcaceae, the Genus Pyrococcus, the Order Thermococcales, the Family Thermococcaceae, the Genus Thermococcus, the Order Thermococcales, the Family Thermococcaceae, the Genus Palaeococcus, the Order Thermales, the Family Thermaceae, the Genus Thermus, and the Order Thermotogales, the Family Thermotogaceae, the Genus Thermotoga.

3. The protein composition of claim 2, wherein the hyperthermophilic organism is from a genus selected from the group consisting of Pyrococcus, Thermococcus, Palaeococcus, Thermus, and Thermotoga.

4. The protein composition of claim 1, wherein the composition comprises DNA from the hyperthermophilic organism.

5. The protein composition of claim 1, wherein the protein composition is substantially free of living or active pathogenic organisms.

6. The protein composition of claim 1, wherein the composition additionally comprises protein from a biomass other than the hyperthermophilic organisms.

7. The protein composition of claim 6, wherein the biomass is selected from the group consisting of fish waste, fish sludge, sewage, agricultural waste products, brewery grain by-products, food industry waste, organic industry waste, forestry waste, crops, grass, seaweed, plankton, algae, fish, fish waste, corn potato waste, cocoa waste, mushroom compost, sugar cane waste, sugar beet waste, straw, paper waste, chicken manure, cow manure, hog manure, horse manure, switchgrass and combinations thereof.

8. The protein composition of claim 7, wherein fish sludge comprises fish feces and waste or uneaten fish feed.

9. The protein composition of claim 7, wherein the protein composition further comprises DNA and or RNA from the biomass.

10. The protein composition of claim 1, wherein the protein composition is a dry powder having a moisture content of less than 8%.

11. An animal feed comprising the protein composition of claim 1.

12. The animal feed of claim 11, wherein the animal feed comprises at least one of a protein source, carbohydrate source, fat source, mineral source, or vitamin source from a source or organism other than the hyperthermophilic organism.

13-32. (canceled)

33. A process for producing a hyperthermophilic organism protein composition comprising:
a) fermenting a biomass material with a hyperthermophilic organism at a temperature of greater than 70° C. to provide a hyperthermophilic fermentation culture;
b) recovering a protein composition from the hyperthermophilic fermentation culture.

34. The process of claim 33, wherein the biomass is selected from the group consisting of fish waste, fish sludge, sewage, agricultural waste products, brewery grain by-products, food industry waste, organic industry waste, forestry waste, crops, grass, seaweed, plankton, algae, fish, fish waste, corn potato waste, cocoa waste, mushroom compost, sugar cane waste, sugar beet waste, straw, paper waste, chicken manure, cow manure, hog manure, horse manure, switchgrass and combinations thereof.

35. The process of claim 34, wherein fish sludge comprises fish feces and waste or uneaten fish feed.

36. The process of claim 33, wherein the hyperthermophilic organism is selected from the group consisting of a member of Order Thermococcales, the Family Thermococcaceae, the Genus Pyrococcus, the Order Thermococcales, the Family Thermococcaceae, the Genus Thermococcus, the Order Thermococcales, the Family Thermococcaceae, the Genus Palaeococcus, the Order Thermales, the Family Thermaceae, the Genus Thermus, and the Order Thermotogales, the Family Thermotogaceae, the Genus Thermotoga.

37-38. (canceled)

39. The process of claim 33, wherein the recovered protein composition further comprises DNA, RNA, sugars, or lipids from the hyperthermophilic organisms.

39. The process of claim 33, wherein the recovered protein composition further comprises protein from the biomass material on which the hyperthermophilic organisms are cultured.

40. (canceled)

41. The process of claim 33, wherein the recovering further comprising concentrating the recovered protein composition by a process selected from the group consisting of coagulation, flocculation, direct drying, spraying drying and vacuum drying and combinations thereof to provide a powder.

42. (canceled)

43. The process of claim 33, further comprising incorporating the recovered protein composition into a feed or food supplement.

44-62. (canceled)
